(19) United States
(12) Patent Application Publication
(10) Pub. No.: US 2009/0085952 A1
(43) Pub. Date: Apr. 2, 2009

(54) TEST CHART, TEST CHART MEASUREMENT METHOD, AND TEST CHART MEASUREMENT APPARATUS

(76) Inventor: Yoshirou YAMAZAKI, Ashigarakami-gun (JP)

Correspondence Address: BIRCH STEWART KOLASCH & BIRCH, PO BOX 747, FALLS CHURCH, VA, 22040-0747, US

(21) Appl. No.: 12/208,151

(22) Filed: Sep. 10, 2008

(30) Foreign Application Priority Data
Sep. 27, 2007 (JP) 2007-252447

(51) Int. Cl. B41J 29/393

(52) U.S. Cl. 347/19

(57) ABSTRACT

A test chart is recorded on a recording medium by means of a line head having a plurality of recording elements by causing the plurality of recording elements to perform recording operation while moving the recording medium and the line head relatively to each other in a relative movement direction. The test chart includes: a line pattern block which includes a plurality of line patterns respectively corresponding to the plurality of recording elements, the plurality of line patterns being arranged at a prescribed interval or above so as to be separated from each other, wherein the plurality of line patterns include reference line patterns arranged on both end regions of the line pattern block, the reference line patterns having line characteristic quantities different from the others of the plurality of line patterns.

### BACKGROUND OF THE INVENTION

1. Field of the Invention

The present invention relates to a test chart and method of measuring same, a test chart measurement apparatus and a computer-readable medium storing instructions causing a computer to measure a test chart, and in particular to a test chart and technology for measuring same suitable for measuring the dot characteristics (e.g., the depositing position, dot diameter, and the occurrence of ejection failures and other abnormalities) of each recording element in a line head installed in an inkjet recording apparatus.

2. Description of the Related Art

In an inkjet recording apparatus having a recording head comprising a plurality of ink ejection ports (nozzles), problems of image quality arise due to the occurrence of density variations (density non-uniformities) in the recorded image caused by variations in the ejection characteristics of the nozzles. In the case of a serial (shuttle) scanning method which performs image recording by moving a recording head a plurality of times over a prescribed printing region, it is possible to avoid density non-uniformities relatively easily by means of a so-called multi-pass printing operation, but in the case of a single-pass method (a line head which performs image recording by means of a single scanning action), using a broad-width line head having a nozzle row corresponding to the width of the paper, it is difficult to avoid density non-uniformity.

In order to improve image quality in printing using a line head of this kind, it is important to adopt measures against stripe-shaped non-uniformities (streaks). One important element of streak correction technology is to accurately measure the characteristics of the recording elements (the dot positions and dot diameters created by the recording elements).

There is known technology for measuring the characteristics of recording elements accurately, rapidly and inexpensively, by reading in the image of a test chart by means of a flatbed scanner (hereinafter, called “scanner”), and measuring the dot positions and dot diameters by analyzing this image. More specifically, this technology involves printing line patterns corresponding to the respective nozzles in a test chart, and then ascertaining the dot positions and dot diameters by measuring the line positions and line widths by means of image analysis.

Japanese Patent Application Publication No. 2006-284406 discloses technology for reading in a test chart (ejection failure determination pattern) by means of a plurality of line sensors which are arranged behind a long recording head. Apart from this, a composition is also known in which a sensor for reading in a test pattern is moved in the breadthways direction of the paper (See Japanese Patent Application Publication No. 2006-35727, and Japanese Patent Application Publication No. 2005-231245).

When printing at high speed in an offset printing system, a line head length of 19 inches and a resolution of 1200 dpi are required, for example. On the other hand, commercially available scanners are often of A4 size and have a reading width of approximately 216 millimeters (8.5 inches), which is not sufficient to read in a test chart produced by a long 19-inch line head as described above, in a single reading action. The same applies to A3 scanners, which have a reading width of 310 millimeters (12.2 inches).

Furthermore, a high reading resolution is necessary in order to be able to measure the characteristics of the recording elements of the line head with a good degree of accuracy. For example, in order to measure a dot diameter of approximately 30 microns (which corresponds to 1200 dpi) in a line pattern, it is necessary to have a reading resolution of 1200 to 4800 dpi, at the least. Providing a high-resolution reading mechanism of this kind inside a printing apparatus increases the cost.

Furthermore, if a reading apparatus is constituted by connecting together a plurality of line sensors as described in Japanese Patent Application Publication No. 2006-284406, then it is difficult to ensure the relative positional accuracy between the respective line sensors, and to convey the paper accurately with respect to the conveyance direction, and this also is a factor which raises the manufacturing costs.

If it is supposed that the measurement of the characteristics of the recording elements is generally carried out once daily, or once every several days, then a mode which uses a scanner or A4 size or the like, which is external to the printing apparatus and which is easy to obtain, is beneficial from a viewpoint of the cost.

### SUMMARY OF THE INVENTION

The present invention has been contrived in view of these circumstances, an object thereof being to provide technology for accurately measuring the characteristics of recording elements (e.g., the dot positions and dot diameters created by the recording elements), by using a scanner having a reading width which is narrower than the effective area of a test pattern formed by all of the recording elements of a line head.

In order to attain the aforementioned object, the present invention is directed to a test chart which is recorded on a recording medium by means of a line head having a plurality of recording elements by causing the plurality of recording elements to perform recording operation while moving the recording medium and the line head relatively to each other in a relative movement direction, the test chart comprising: a line pattern block which includes a plurality of line patterns respectively corresponding to the plurality of recording elements, the plurality of line patterns being arranged at a prescribed interval or above so as to be separated from each other, wherein the plurality of line patterns include reference line patterns arranged on both end regions of the line pattern block, the reference line patterns having line characteristic quantities different from the others of the plurality of line patterns.

According to this aspect of the present invention, even if a portion of the reference line patterns is omitted due to a recording abnormality, it is possible to identify the recording abnormality on the basis of the remaining line patterns, and hence the line positions of all of the recording elements including those suffering recording abnormalities can be identified.

The prescribed interval is set previously to a value so as to avoid mutual overlap between the respective line patterns and allows the line patterns to be read out independently as individual lines.

Preferably, the reference line patterns include a first reference line pattern having a first line characteristic quantity and a second reference line pattern having a second line characteristic quantity, the first line characteristic quantity being different from the second line characteristic quantity.

According to this aspect of the present invention, a missing line pattern can be identified readily by differentiating the line characteristic quantity.

Preferably, the test chart includes a plurality of the line pattern blocks; and a row of the plurality of recording elements is divided into a plurality of recording element regions which form the line pattern blocks respectively, the plurality of recording element regions mutually overlapping so that the reference line patterns in adjacent two of the line pattern blocks are recorded by common recording elements belonging to two of the recording element regions corresponding to the adjacent two of the line pattern blocks.

According to this aspect of the present invention, reference line patterns in adjacent two of the line pattern blocks are formed by using the common recording elements corresponding to the adjacent two of the line pattern blocks. Hence, even when forming a plurality of line pattern blocks at different positions (regions) on the same recording medium, it is possible to adjust the respective positions of the line pattern blocks by using the information relating to the reference line patterns which are formed by the common recording elements.

Preferably, the plurality of recording elements in the line head are arranged at mutually different positions in a first direction that intersects with the relative movement direction; the test chart includes a plurality of the line pattern blocks, a number of the line pattern blocks in the test chart being a that is an integer not less than 2, the line pattern blocks being arranged at mutually different positions in a second direction that is parallel with a direction in which each of the plurality of line patterns extends; and when recording element numbers j (j=0, 1, 2, . . . , N−1) are assigned to the plurality of recording elements sequentially from one end of a sequence of the plurality of recording elements, and when a remainder value generated by dividing each of the recording element numbers by the integer α is taken to be R (R=0, 1, . . . , α−1), each of the line pattern blocks is formed by a group of the plurality of recording elements having the same remainder value R so that the line pattern blocks are formed for the remainder values R, respectively.

According to this aspect of the present invention, it is possible to arrange line patterns corresponding to all of the recording elements in a configuration whereby each line pattern can be read out respectively and independently, and it is possible readily to calculate the line positions within each line pattern block and between the line pattern blocks.

Preferably, the above-described test chart further includes a plurality of test patterns each of which is constituted of the line pattern blocks corresponding to the remainder values R, the test patterns having mutually different arrangement sequences of the line pattern blocks, the test patterns being identifiable based on the arrangement sequences of the line pattern blocks.

According to this aspect of the present invention, it is possible to identify the test pattern on the basis of the arrangement sequences of the line pattern blocks by previously determining correspondence between the test pattern and the arrangement sequence of the line pattern blocks which are divided according to the remainder value.

In order to attain the aforementioned object, the present invention is also directed to a test chart measurement method, comprising the steps of: reading in a test chart which includes a line pattern block including a plurality of line patterns respectively corresponding to the plurality of recording elements, the plurality of line patterns being arranged at a prescribed interval or above so as to be separated from each other, wherein the plurality of line patterns include reference line patterns arranged on both end regions of the line pattern block, the reference line patterns having line characteristic quantities different from the others of the plurality of line patterns, the test chart being read in to obtain an image of the test chart by means of an image reading device; and identifying an abnormal recording element in the plurality of recording elements from the image of the test chart obtained in the step of reading in the test chart, according to distribution of the reference line patterns having the line characteristic quantities different from the others of the plurality of line patterns.

Moreover, in order to attain the aforementioned object, the present invention is also directed to a test chart measurement method, comprising the steps of: reading in a test chart which includes a line pattern block including a plurality of line patterns respectively corresponding to the plurality of recording elements, the plurality of line patterns being arranged at a prescribed interval or above so as to be separated from each other, wherein the plurality of line patterns include reference line patterns arranged on both end regions of the line pattern block, the reference line patterns having line characteristic quantities different from the others of the plurality of line patterns, the test chart including a plurality of the line pattern blocks; and a row of the plurality of recording elements is divided into a plurality of recording element regions which form the line pattern blocks respectively, the plurality of recording element regions mutually overlapping so that the reference line patterns in adjacent two of the line pattern blocks are recorded by common recording elements belonging to two of the recording element regions corresponding to the adjacent two of the line pattern blocks, the test chart being read in to obtain images respectively for regions of the test chart corresponding to the plurality of recording element regions; and identifying an abnormal recording element in the plurality of recording elements by analyzing the images of the test chart obtained in the step of reading in the test chart, according to distribution of the reference line patterns having the line characteristic quantities different from the others of the plurality of line patterns.

In order to attain the aforementioned object, the present invention is also directed to a test chart measurement apparatus, comprising: an image reading device which reads a test chart to convert the test chart to image data, the test chart including a line pattern block including a plurality of line patterns respectively corresponding to the plurality of recording elements, the plurality of line patterns being arranged at a prescribed interval or above so as to be separated from each other, wherein the plurality of line patterns include reference line patterns arranged on both end regions of the line pattern block, the reference line patterns having line characteristic quantities different from the others of the plurality of line patterns; and a calculation processing device which analyzes the image data of the test chart obtained by the image reading device to identify an abnormal recording element in the plurality of recording elements, according to distribution of the reference line patterns having the line characteristic quantities different from the others of the plurality of line patterns.

Preferably, the calculation processing device includes: information identification device which identifies information relating to positions, line widths and the line characteristic quantities of the line patterns of the line pattern blocks in the image data of the test chart obtained by the image reading device; and abnormal line judgment device which judges whether or not there exist an abnormal line pattern in the line patterns, according to previously known information relating to the line characteristic quantities and the distribution of the reference line patterns, the abnormal line pattern being formed by the abnormal recording element.

In order to attain the aforementioned object, the present invention is also directed to a computer readable medium storing instructions causing a computer to function as the information identification device and the abnormal line judgment device in the above described test chart measurement apparatus.

One compositional example of a line head according to an embodiment of the present invention is a full line type head in which a plurality of nozzles are arranged through a length corresponding to the full width of the recording medium. In this case, a mode may be adopted in which a plurality of relatively short recording head modules having nozzles rows which do not reach a length corresponding to the full width of the recording medium are combined and joined together, thereby forming nozzle rows of a length that correspond to the full width of the recording medium.

A full line type head is usually arranged to extend in a direction that is perpendicular to the feed direction (conveyance direction) of the recording medium, but a mode may also be adopted in which the head is arranged so as to extend in an oblique direction that forms a prescribed angle with respect to the direction perpendicular to the conveyance direction.

Here, “recording medium” is a general term for a medium on which dots are recorded by recording elements, and it includes an ejection receiving medium, print medium, image forming medium, image receiving medium, intermediate transfer body, or the like, which receives the deposition of liquid droplets ejected from the nozzles (ejection ports) of an inkjet head. There are no particular restrictions on the shape or material of the medium, which may be various types of media, irrespective of material and size, such as continuous paper, cut paper, sealed paper, resin sheets, such as OHP sheets, film, cloth, a printed circuit substrate on which a wiring pattern, or the like, is formed, a rubber sheet, a metal sheet, or the like.

The conveyance device for causing the recording medium and the line head to move relative to each other may include a mode where the recording medium is conveyed with respect to a stationary (fixed) head, or a mode where a head is moved with respect to a stationary recording medium, or a mode where both the head and the recording medium are moved. When forming color images by using an inkjet head, it is possible to provide recording heads for each color of a plurality of colored inks (recording liquids), or it is possible to eject inks of a plurality of colors, from one print head.

For the image reading apparatus used to carry out an embodiment of the present invention, it is possible to employ a line sensor (linear image sensor), or to employ an area sensor. The reading resolution depends on the size of the dots under measurement, but for example, a resolution of 1200 dpi or above is desirable for measuring the dots in an inkjet printer which achieves photo-quality image recording.

If the liquids subject to measurement are liquids of a plurality of types having different absorption characteristics, for instance, in the case of measuring line patterns formed by inks of a plurality of colors, it is desirable to use a color image sensor which is capable of separating the different colors, as the imaging apparatus. For example, an imaging device equipped with RGB primary color filters, or an imaging device equipped with CMY complementary color filters is used.

When using a color image sensor, it is desirable to use the signal of the color channel which produces the greatest contrast by taking account of the absorption spectrum of the object under measurement.

According to the present invention, since a plurality of reference line patterns having differentiated line characteristic quantities are arranged at either end portion of the line pattern block, then even supposing that a portion of the reference line patterns were to be omitted due to a recording abnormality, it is still possible to identify the line patterns on the basis of a previously ascertained distribution of the reference line patterns. Therefore, it is possible to measure the position of the line patterns within the test chart, accurately.

Furthermore, according to the present invention, it is possible to identify the respective line positions by accurately joining together the positions between test charts which have been read in by a plurality of reading operations, using an image reading apparatus having an image reading width that is narrower than the recording width of the line head.

### BRIEF DESCRIPTION OF THE DRAWINGS

The nature of the present invention, as well as other objects and advantages thereof, will be explained in the following with reference to the accompanying drawings, in which like reference characters designate the same or similar parts throughout the figures and wherein:

FIG. 1 is a general schematic drawing of an inkjet recording apparatus;

FIGS. 2A and 2B are plan view perspective diagrams showing an example of the composition of a print head;

FIG. 3 is a plan view perspective diagram showing a further example of the composition of a full line head;

FIG. 4 is a cross-sectional view along line 4-4 in FIGS. 2A and 2B;

FIG. 5 is an enlarged diagram showing an example of the arrangement of nozzles in a head;

FIG. 6 is a block diagram showing the system composition of the inkjet recording apparatus;

FIG. 7 is a schematic drawing showing irregularities in line patterns caused by nozzle characteristics;

FIG. 8 is a diagram showing an example of the composition of line pattern blocks in a test chart;

FIGS. 9A to 9C are diagrams showing the relationship between a test chart which has been printed by a broad-width line head having a high recording density, and a scanning apparatus which reads in this test chart;

FIG. 10 is a diagram showing a first example of a test chart to be split, according to a first mode;

FIG. 11 is a diagram showing an example of a split test chart which has been cut up;

FIG. 12 is an illustrative diagram for describing problems occurring in the event of an ejection failure at the end of a line pattern block;

FIG. 13 is a diagram showing examples of line pattern blocks according to an embodiment of the present invention;

FIG. 14 is a flowchart of ejection failure judgment processing for a line pattern block;

FIG. 15 is an illustrative diagram of the analysis range of a line pattern block;

FIG. 16 is an illustrative diagram of a method for setting the line pattern block analysis range in a test chart;

FIG. 17 is an illustrative diagram showing a concrete example of internal ejection failure judgment processing;

FIG. 18 is a table showing an example of line pattern block information obtained by image analysis;

FIG. 19 is a table showing an example of line pattern block information obtained by internal ejection failure judgment processing;

FIG. 20 is a flowchart of internal ejection failure judgment processing;

FIG. 21 is a table showing an example of line pattern block information obtained by external ejection failure judgment processing;

FIG. 22 is a flowchart of external ejection failure judgment processing;

FIG. 23 is a diagram showing a first example of a test pattern used to describe how to adjust the positions between line pattern blocks;

FIG. 24 is a diagram showing a second example of a test pattern used to describe how to adjust the positions between line pattern blocks;

FIG. 25 is a diagram showing a third example of a test pattern used to describe how to adjust the positions between line pattern blocks;

FIG. 26 is an illustrative diagram of positional alignment processing between blocks;

FIG. 27 is an illustrative diagram of an example of forming test charts having different arrangement sequences of the line pattern blocks;

FIG. 28 is a flowchart of test pattern identification processing;

FIG. 29 is a flowchart of processing for determining the absolute positional information for all of the nozzles;

FIG. 30 is a flowchart showing an algorithm of the whole process from output of the test chart until reading of the test chart;

FIG. 31 is a block diagram showing an example of the composition of a test chart measurement apparatus;

FIG. 32 is a diagram showing an example of a single-sheet test chart, according to a second mode;

FIG. 33 is a diagram showing the relationship between a single-sheet test chart and the image reading ranges;

FIG. 34 is a diagram showing a further example of a single-sheet test chart; and

FIG. 35 is a diagram showing the relationship between the single-sheet test chart in FIG. 34 and the image reading range.

### DETAILED DESCRIPTION OF THE PREFERRED EMBODIMENTS

A preferred embodiment of the present invention is described below, with reference to figures.

Here, an example of the application to the measurement of the dot deposition positions and dot diameters of the ink dots formed by an inkjet recording apparatus is described. Firstly, the overall composition of an inkjet recording apparatus will be described.

### Description of Inkjet Recording Apparatus

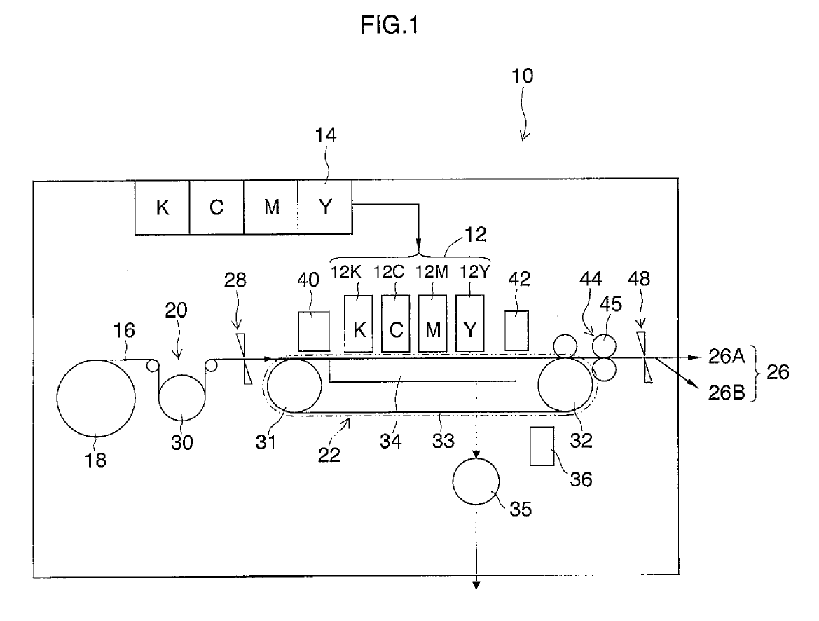

FIG. 1 is a general schematic drawing of an inkjet recording apparatus. As shown in FIG. 1, the inkjet recording apparatus 10 comprises: a print unit 12 having a plurality of inkjet recording heads (corresponding to “liquid ejection heads”, hereinafter, called “heads”) 12K, 12C, 12M and 12Y provided for ink colors of black (K), cyan (C), magenta (M), and yellow (Y), respectively; an ink storing and loading unit 14 for storing inks to be supplied to the heads 12K, 12C, 12M and 12Y; a paper supply unit 18 for supplying recording paper 16 forming a recording medium; a decurling unit 20 for removing curl in the recording paper 16; a belt conveyance unit 22, disposed facing the nozzle face (ink ejection face) of the print unit 12, for conveying the recording paper 16 while keeping the recording paper 16 flat; and a paper output unit 26 for outputting recorded recording paper (printed matter) to the exterior.

The ink storing and loading unit 14 has ink tanks for storing the inks of each color to be supplied to the heads 12K, 12C, 12M, and 12Y respectively, and the tanks are connected to the heads 12K, 12C, 12M, and 12Y by means of prescribed channels. The ink storing and loading unit 14 has a warning device (for example, a display device or an alarm sound generator) for warning when the remaining amount of any ink is low, and has a mechanism for preventing loading errors among the colors.

In FIG. 1, a magazine for rolled paper (continuous paper) is shown as an example of the paper supply unit 18; however, a plurality of magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording medium (media) can be used, it is preferable that a medium such as a bar code and a wireless tag containing information about the type of medium is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

In the case of the configuration in which roll paper is used, a cutter (first cutter) 28 is provided as shown in FIG. 1, and the continuous paper is cut into a desired size by the cutter 28.

The decurled and cut recording paper 16 is delivered to the belt conveyance unit 22. The belt conveyance unit 22 has a configuration in which an endless belt 33 is set around rollers 31 and 32 so that the portion of the endless belt 33 facing at least the nozzle face of the print unit 12 forms a horizontal plane (flat plane).

The belt 33 has a width that is greater than the width of the recording paper 16, and a plurality of suction apertures (not shown) are formed on the belt surface. A suction chamber 34 is disposed in a position facing the nozzle surface of the print unit 12 on the interior side of the belt 33, which is set around the rollers 31 and 32, as shown in FIG. 1. The suction chamber 34 provides suction with a fan 35 to generate a negative pressure, and the recording paper 16 is held on the belt 33 by suction. It is also possible to use an electrostatic attraction method, instead of a suction-based attraction method.

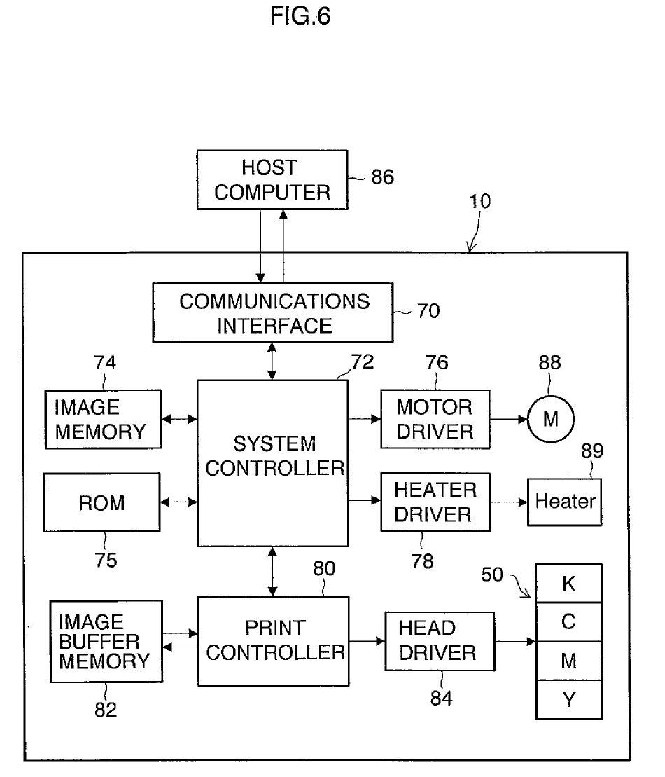

The belt 33 is driven in the clockwise direction in FIG. 1 by the motive force of a motor 88 (shown in FIG. 6) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, examples thereof include a configuration of nipping with a brush roller and a water absorbent roller or the like, an air blow configuration of blowing clean air, or a combination of these.

Instead of the belt conveyance unit 22, it is also possible to adopt a mode which uses a roller nip conveyance mechanism, but when the print region is conveyed by a roller nip mechanism, the printed surface of the paper makes contact with the roller directly after printing, and hence there is a problem in that the image is liable to be blurred. Therefore, a suction belt conveyance mechanism which does not make contact with the image surface in the print region is desirable, as in the present example.

A heating fan 40 is disposed on the upstream side of the print unit 12 in the conveyance pathway formed by the belt conveyance unit 22. The heating fan 40 blows heated air onto the recording paper 16 to heat the recording paper 16 immediately before printing so that the ink deposited on the recording paper 16 dries more easily.

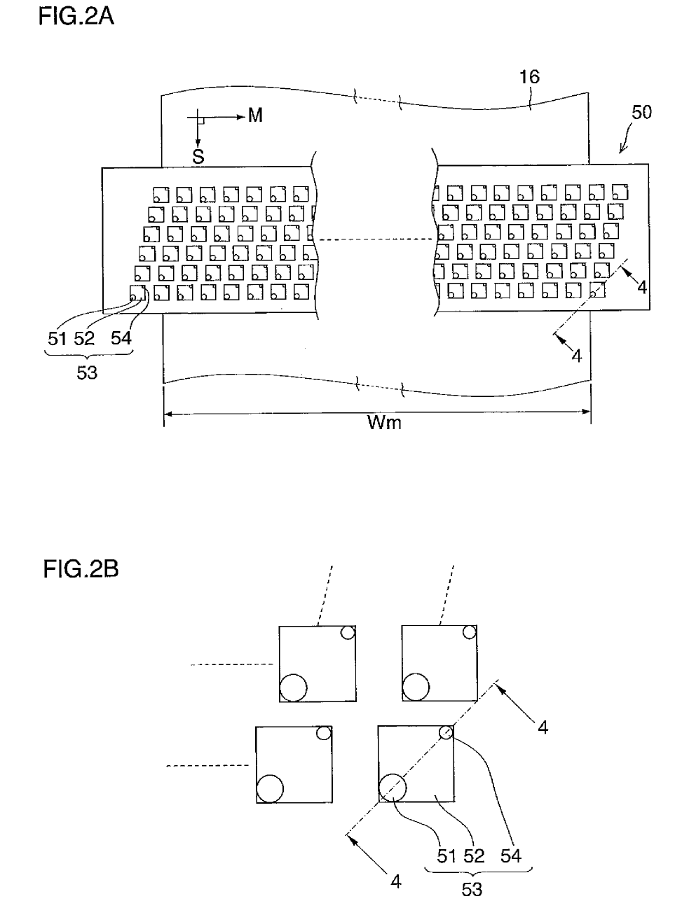

The heads 12K, 12C, 12M and 12Y of the print unit 12 are full line heads having a length corresponding to the maximum width of the recording paper 16 used with the inkjet recording apparatus 10, and comprising a plurality of nozzles for ejecting ink arranged on a nozzle face through a length exceeding at least one edge of the maximum-size recording medium (namely, the full width of the printable range) (see FIGS. 2A and 2B).

The print heads 12K, 12C, 12M and 12Y are arranged in color order (black (K), cyan (C), magenta (M), yellow (Y)) from the upstream side in the feed direction of the recording paper 16, and these respective heads 12K, 12C, 12M and 12Y are fixed extending in a direction substantially perpendicular to the conveyance direction of the recording paper 16.

A color image can be formed on the recording paper 16 by ejecting inks of different colors from the heads 12K, 12C, 12M and 12Y, respectively, onto the recording paper 16 while the recording paper 16 is conveyed by the belt conveyance unit 22.

By adopting a configuration in which the full line heads 12K, 12C, 12M and 12Y having nozzle rows covering the full paper width are provided for the respective colors in this way, it is possible to record an image on the full surface of the recording paper 16 by performing just one operation of relatively moving the recording paper 16 and the print unit 12 in the paper conveyance direction (the sub-scanning direction), in other words, by means of a single sub-scanning action. Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

A post-drying unit 42 is disposed following the print unit 12. The post-drying unit 42 is a device to dry the printed image surface, and includes a heating fan, for example. It is preferable to avoid contact with the printed surface until the printed ink dries, and a device that blows heated air onto the printed surface is preferable.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. Although not shown in FIG. 1, the paper output unit 26A for the target prints is provided with a sorter for collecting prints according to print orders.

### Structure of the Head

Next, the structure of a head will be described. The heads 12K, 12C, 12M and 12Y of the respective ink colors have the same structure, and a reference numeral 50 is hereinafter designated to any of the heads.

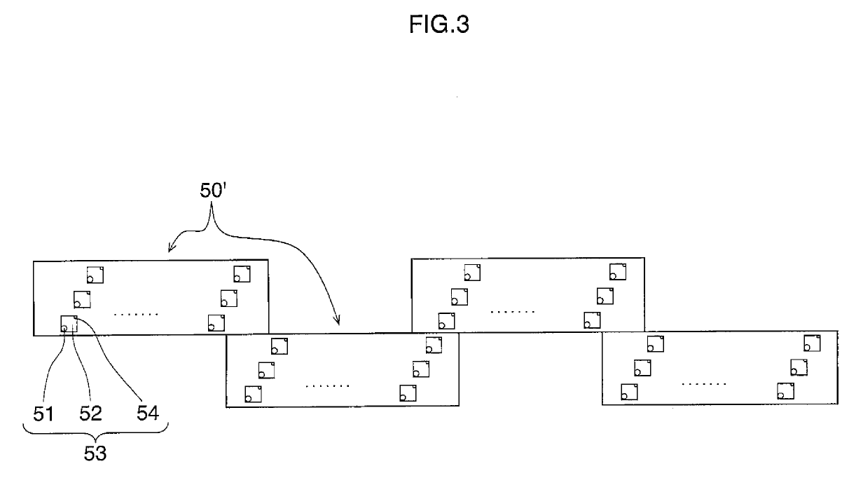

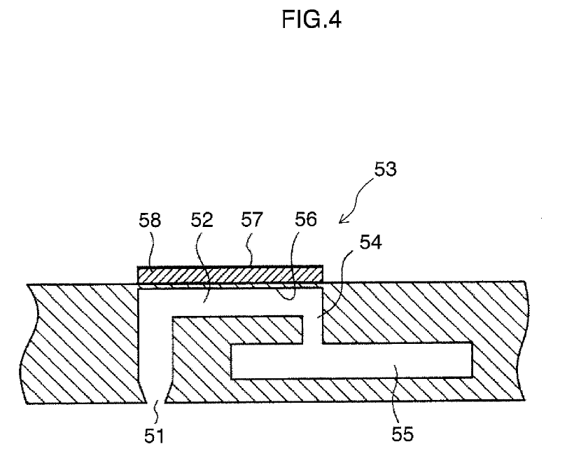

FIG. 2A is a plan view perspective diagram showing an example of the structure of a head 50, and FIG. 2B is an enlarged diagram of a portion of same. Furthermore, FIG. 3 is a plan view perspective diagram (a cross-sectional view along the line 4-4 in FIGS. 2A and 2B) showing another example of the structure of the head 50, and FIG. 4 is a cross-sectional diagram showing the three-dimensional composition of the liquid droplet ejection element corresponding to one channel which forms a unit recording element (namely, an ink chamber unit corresponding to one nozzle 51).

The nozzle pitch in the head 50 should be minimized in order to maximize the density of the dots printed on the surface of the recording paper 16. As shown in FIGS. 2A and 2B, the head 50 according to the present embodiment has a structure in which a plurality of ink chamber units (droplet ejection elements) 53, each comprising a nozzle 51 forming an ink ejection port, a pressure chamber 52 corresponding to the nozzle 51, and the like, are disposed two-dimensionally in the form of a staggered matrix, and hence the effective nozzle interval (the projected nozzle pitch) as projected (orthogonal projection) in the lengthwise direction of the head (the direction perpendicular to the paper conveyance direction) is reduced and high nozzle density is achieved.

The mode of forming nozzle rows with a length not less than a length corresponding to the entire width Wm of the recording paper 16 in a direction (the direction of arrow M; main-scanning direction) substantially perpendicular to the conveyance direction (the direction of arrow S; sub-scanning direction) of the recording paper 16 is not limited to the example described above. For example, instead of the configuration in FIG. 2A, as shown in FIG. 3, a line head having nozzle rows of a length corresponding to the entire width of the recording paper 16 can be formed by arranging and combining, in a staggered matrix, short head modules 50′ having a plurality of nozzles 51 arrayed in a two-dimensional fashion.

As shown in FIGS. 2A and 2B, the planar shape of the pressure chamber 51 provided corresponding to each nozzle 52 is substantially a square shape, and an outlet port to the nozzle 51 is provided at one of the ends of a diagonal line of the planar shape, while an inlet port (supply port) 54 for supplying ink is provided at the other end thereof. The shape of the pressure chamber 52 is not limited to that of the present example and various modes are possible in which the planar shape is a quadrilateral shape (diamond shape, rectangular shape, or the like), a pentagonal shape, a hexagonal shape, or other polygonal shape, or a circular shape, elliptical shape, or the like.

As shown in FIG. 4, each pressure chamber 52 is connected to a common channel 55 through the supply port 54. The common channel 55 is connected to an ink tank (not shown in Figures), which is a base tank that supplies ink, and the ink supplied from the ink tank is delivered through the common flow channel 55 to the pressure chambers 52.

An actuator 58 provided with an individual electrode 57 is bonded to a pressure plate (a diaphragm that also serves as a common electrode) 56 which forms the surface of one portion (in FIG. 4, the ceiling) of the pressure chambers 52. When a drive voltage is applied to the individual electrode 57 and the common electrode, the actuator 58 deforms, thereby changing the volume of the pressure chamber 52. This causes a pressure change which results in ink being ejected from the nozzle 51. For the actuator 58, it is possible to adopt a piezoelectric element using a piezo electric body, such as lead zirconate titanate, barium titanate, or the like. When the displacement of the actuator 58 returns to its original position after ejecting ink, the pressure chamber 52 is replenished with new ink from the common channel 55 via the supply port 54.

By controlling the driving of the actuators 58 corresponding to the nozzles 51 in accordance with the dot arrangement data generated from the input image, it is possible to eject ink droplets from the nozzles 51. By controlling the ink ejection timing of the nozzles 51 in accordance with the speed of conveyance of the recording paper 16, while conveying the recording paper in the sub-scanning direction at a uniform speed, it is possible to record a desired image on the recording paper 16.

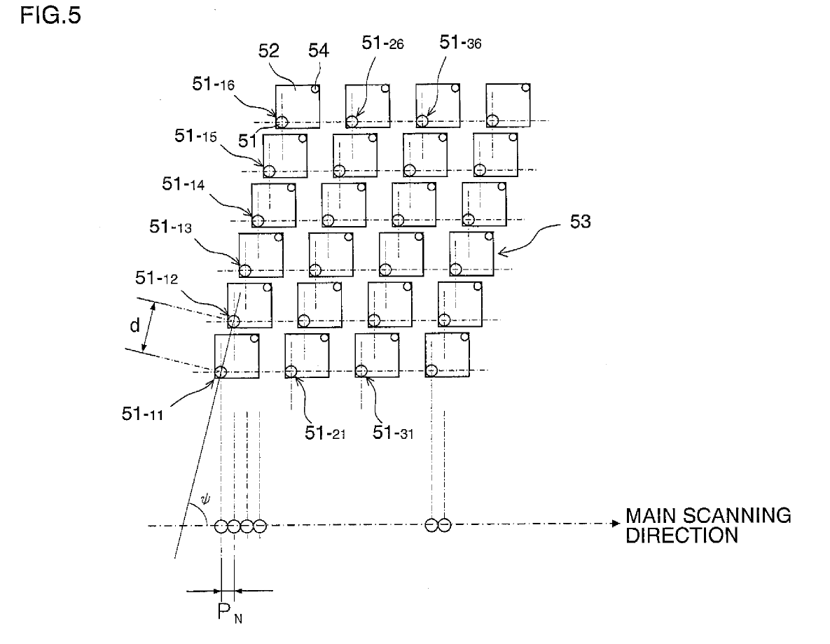

As shown in FIG. 5, the high-density nozzle head according to the present embodiment is achieved by arranging obliquely a plurality of ink chamber units 53 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 53 are arranged at a uniform pitch d in line with a direction forming an angle of ψ with respect to the main scanning direction, the pitch PN of the nozzles projected so as to align in the main scanning direction is d×cos ψ, and hence the nozzles 51 can be regarded to be substantially equivalent to those arranged linearly at a fixed pitch P along the main scanning direction. Such configuration results in a nozzle structure in which the nozzle row projected in the main scanning direction has a high nozzle density of up to 2,400 nozzles per inch.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording paper (the direction perpendicular to the conveyance direction of the recording paper) by driving the nozzles in, for example, following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 51 arranged in a matrix such as that shown in FIG. 5 are driven, the main scanning according to the above-described (3) is preferred. More specifically, the nozzles 51-11, 51-12, 51-13, 51-14, 51-15 and 51-16 are treated as a block (additionally; the nozzles 51-21, 51-22, . . . , 51-26 are treated as another block; the nozzles 51-31, 51-32, . . . , 51-36 are treated as another block; . . . ); and one line is printed in the width direction of the recording paper 16 by sequentially driving the nozzles 51-11, 51-12, . . . , 51-16 in accordance with the conveyance velocity of the recording paper 16.

On the other hand, “sub-scanning” is defined as to repeatedly perform printing of one line (a line formed of a row of dots, or a line formed of a plurality of rows of dots) formed by the main scanning, while moving the full-line head and the recording paper relatively to each other.

The direction indicated by one line (or the lengthwise direction of a band-shaped region) recorded by main scanning as described above is called the “main scanning direction”, and the direction in which sub-scanning is performed, is called the “sub-scanning direction”. In other words, in the present embodiment, the conveyance direction of the recording paper 16 is called the sub-scanning direction and the direction perpendicular to same is called the main scanning direction.

In implementing the present invention, the arrangement of the nozzles is not limited to that of the example illustrated. Moreover, a method is employed in the present embodiment where an ink droplet is ejected by means of the deformation of the actuator 58, which is typically a piezoelectric element; however, in implementing the present invention, the method used for discharging ink is not limited in particular, and instead of the piezo jet method, it is also possible to apply various types of methods, such as a thermal jet method where the ink is heated and bubbles are caused to form therein by means of a heat generating body such as a heater, ink droplets being ejected by means of the pressure applied by these bubbles.

### Description of Control System

FIG. 6 is a block diagram showing the system configuration of the inkjet recording apparatus 10. As shown in FIG. 6, the inkjet recording apparatus 10 comprises a communication interface 70, a system controller 72, an image memory 74, a ROM 75, a motor driver 76, a heater driver 78, a print controller 80, an image buffer memory 82, a head driver 84, and the like.

The communication interface 70 is an interface unit (image input unit) for receiving image data sent from a host computer 86. A serial interface such as USB (Universal Serial Bus), IEEE 394, Ethernet (registered trademark), wireless network, or a parallel interface such as a Centronics interface may be used as the communication interface 70. A buffer memory (not shown) may be mounted in this portion in order to increase the communication speed.

The image data sent from the host computer 86 is received by the inkjet recording apparatus 10 through the communication interface 70, and is stored temporarily in the image memory 74. The image memory 74 is a storage device for storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is constituted by a central processing unit (CPU) and peripheral circuits thereof, and the like, and it functions as a control device for controlling the whole of the inkjet recording apparatus 10 in accordance with a prescribed program, as well as a calculation device for performing various calculations. More specifically, the system controller 72 controls the various sections, such as the communication interface 70, image memory 74, motor driver 76, heater driver 78, and the like, as well as controlling communications with the host computer 86 and writing and reading to and from the image memory 74 and ROM 75, and it also generates control signals for controlling the motor 88 and heater 89 of the conveyance system.

The program executed by the CPU of the system controller 72 and the various types of data (including data for printing a test chart described later, and a program for creating same) which are required for control procedures are stored in the ROM 75. The ROM 75 may be a non-writeable storage device, or it may be a rewriteable storage device, such as an EEPROM. The image memory 74 is used as a temporary storage region for the image data, and it is also used as a program development region and a calculation work region for the CPU.

The motor driver (drive circuit) 76 drives the motor 88 of the conveyance system in accordance with commands from the system controller 72. The heater driver (drive circuit) 78 drives the heater 89 of the post-drying unit 42 or the like in accordance with commands from the system controller 72.

The print controller 80 has a signal processing function for performing various tasks, compensations, and other types of processing for generating print control signals from the image data (original image data) stored in the image memory 74 in accordance with commands from the system controller 72 so as to supply the generated print data (dot data) to the head driver 84.

The print controller 80 is provided with the image buffer memory 82; and image data, parameters, and other data are temporarily stored in the image buffer memory 82 when image data is processed in the print controller 80. The aspect shown in FIG. 6 is one in which the image buffer memory 82 accompanies the print controller 80; however, the image memory 74 may also serve as the image buffer memory 82. Also possible is an aspect in which the print controller 80 and the system controller 72 are integrated to form a single processor.

To give a general description of the sequence of processing from image input to print output, image data to be printed (original image data) is input from an external sorce via a communications interface 70, and is accumulated in the image memory 74. At this stage, RGB image data is stored in the image memory 74, for example.

In this inkjet recording apparatus 10, an image which appears to have a continuous tonal graduation to the human eye is formed by changing the droplet ejection density and the dot size of fine dots created by ink (coloring material), and therefore, it is necessary to convert the input digital image into a dot pattern which reproduces the tonal gradations of the image (namely, the light and shade toning of the image) as faithfully as possible. Therefore, original image data (RGB data) stored in the image memory 74 is sent to the print controller 80 through the system controller 72, and is converted to the dot data for each ink color by a half-toning technique, using a threshold value matrix, error diffusion, or the like, in the print controller 80.

In other words, the print controller 80 performs processing for converting the input RGB image data into dot data for the four colors of K, C, M and Y. The dot data generated by the print controller 180 in this way is stored in the image buffer memory 82.

The head driver 84 outputs a drive signal for driving the actuators 58 corresponding to the nozzles 51 of the head 50, on the basis of print data (in other words, dot data stored in the image buffer memory 182) supplied by the print controller 80. A feedback control system for maintaining constant drive conditions in the head may be included in the head driver 84.

By supplying the drive signal output by the head driver 84 to the head 50, ink is ejected from the corresponding nozzles 51. By controlling ink ejection from the print heads 50 in synchronization with the conveyance speed of the recording paper 16, an image is formed on the recording paper 16.

As described above, the ejection volume and the ejection timing of the ink droplets from the respective nozzles are controlled via the head driver 84, on the basis of the dot data generated by implementing prescribed signal processing in the print controller 80, and the drive signal waveform. By this means, prescribed dot sizes and dot positions can be achieved.

Furthermore, the print controller 80 carries out various corrections with respect to the head 50, on the basis of information on the dot depositing positions and dot diameters (ink volume) acquired by the test chart reading method described below, and furthermore, it implements control for carrying out cleaning operations (nozzle restoration operations), such as preliminary ejection or suctioning, or wiping, according to requirements.

### Method for Creating and Reading Test Chart

Next, the method for creating and reading a test chart according to the present embodiment will be described.

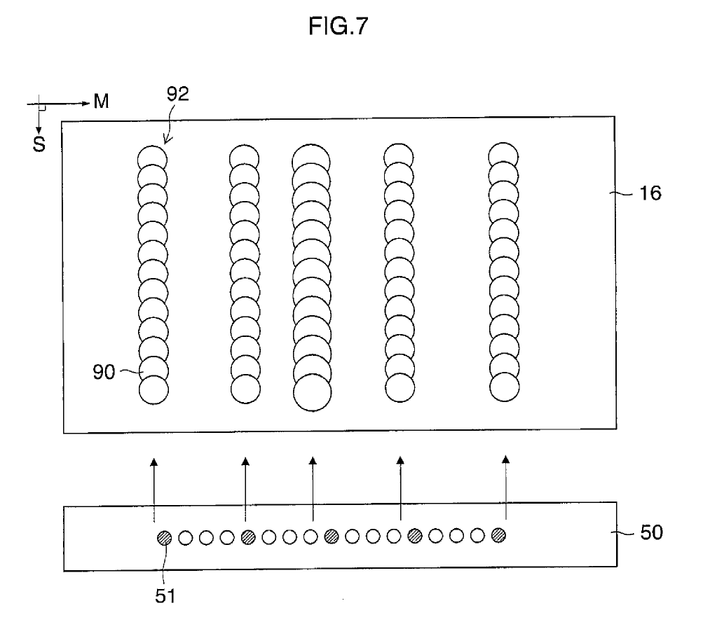

Firstly, the test chart is described below. FIG. 7 is a schematic drawing showing an example of the line patterns formed on the recording paper by means of an inkjet head. In FIG. 7, the vertical direction (sub-scanning direction) indicated by the arrow S represents the conveyance direction of the recording paper, and the lateral direction (the main scanning direction) indicated by the arrow M, which is perpendicular to the direction S, represents the longitudinal direction of the head 50. In FIG. 7, in order to simplify the description, a head having a plurality of nozzles aligned in one row is shown as an example, but as described in FIG. 3, it is also possible to employ a matrix head in which a plurality of nozzles are arranged two-dimensionally. In other words, a group of nozzles arranged in a two-dimensional configuration can be treated as being substantially equivalent to a nozzle configuration in a single row, by considering the effective nozzle row formed by projecting the nozzles normally to a straight line in the main scanning direction.

By conveying the recording paper 16 while ejecting liquid droplets from the nozzles 51 of the head 50 toward the recording paper 16, ink droplets deposit on the recording paper 16, and as shown in FIG. 7, dot rows (line patterns 92) are formed which include dots 90 formed by the ink droplets deposited from the nozzles 51, arranged in the form of lines.

FIG. 7 shows an example of line patterns 92 formed on a sheet of recording paper 16 when there is fluctuation in the deposition positions and ink volume of the actually ejected ink droplets, in relation to the regular nozzle arrangement in the head 50.

Here, a “line pattern” means a line of a prescribed line created by one dot row in the sub-scanning direction which is formed by continuous droplet ejection from one nozzle, and hence a “line pattern” is a single line of dots arranged in the sub-scanning direction which are formed by one nozzle.

Each of the line patterns 92 is formed by droplets ejected from corresponding one of the nozzles. In the case of a line head having a high recording density, when droplets are ejected simultaneously from all of the nozzles, the dots created by mutually adjacent nozzles overlap partially with each other, and therefore single dot lines are not formed. In order that the line patterns 92 formed by droplet ejection from the respective nozzles 51 do not overlap with each other, it is desirable to leave a space of at least one nozzle, and more desirably, three or more nozzles, between the nozzles which perform ejection simultaneously.

FIG. 7 shows an example in which a space of three nozzles is left. The respective line patterns reflect the characteristics of the corresponding nozzles, and due to the characteristics of the individual nozzles, variation occurs in the deposition position (dot position) or the dot diameter, giving rise to irregularity in the line pattern.

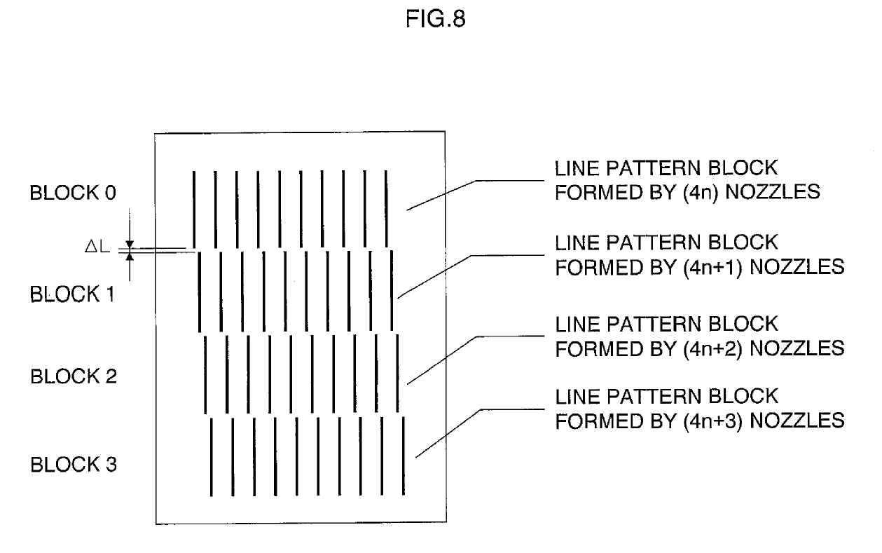

In order to obtain (isolated) non-overlapping line patterns for each of the nozzles 51 in the head 50, for example, a chart such as that shown in FIG. 8 is formed. In FIG. 8, the respective line patterns are indicated by thick lines in the vertical direction, but when observed closely, each line is formed by a plurality of ink dots which are arranged in an overlapping fashion following a straight line, as shown in FIG. 7.

To describe a case where a three-nozzle interval is allowed between line patterns in order to avoid overlapping between the line patterns of different nozzles, a nozzle number i (i=0, 1, 2, 3, . . . ) is assigned to each nozzle successively from the end of the nozzle row in the head 50, and taking n to be an integer equal to or greater than zero, the nozzles are divided into groups having nozzle numbers of 4n, 4n+1, 4n+2 and 4n+3, and line patterns are formed respectively by staggering the droplet ejection timings of the respective groups.

A block of line patterns (namely, a row of line patterns which are arranged regularly in the breadthways direction of the recording paper at intervals of a prescribed number of nozzles apart) formed by a unit group (4n, 4n+1, 4n+2, 4n+3) of nozzle numbers which are used simultaneously, as shown in FIG. 8, is known as a “line pattern block” or simply a “block”. A plurality of line pattern blocks (in the present case, four blocks) which have been formed by using different nozzle number groups and in which each of the nozzles have been employed in any of the plurality of blocks, is called one “test pattern”. In other words, the “test pattern” is constituted of a plurality of line pattern blocks

In the case of four blocks as shown in FIG. 8, block 0 is created by line patterns formed by using nozzles (i.e., nozzles having nozzle numbers of 4n) having a nozzle number which is a multiple of 4, namely, a nozzle number of 0, 4, 8, and so on. Thereupon, a small interval (ΔL) is allowed in the lengthwise direction of the line pattern (the conveyance direction of the recording paper), and the block 1 is formed. This block 1 is created by line patterns formed using nozzles (i.e., nozzles having nozzle numbers of 4n+1) having a nozzle number which is a multiple of 4 plus 1, namely, a nozzle number of 1, 5, 9, and so on. Thereafter, line patterns are formed in a similar fashion using the nozzles (i.e., nozzles having nozzle numbers of 4n+2) having a nozzle number which is a multiple of 4 plus 2, for block 2, and using nozzles (i.e., nozzles having nozzle numbers of 4n+3) having a nozzle number which is a multiple of 4 plus 3, for block 3.

Consequently, it is possible to form isolated line patterns (which do not overlap with other lines), for all of the nozzles, without any mutual overlapping between the line patterns of the respective blocks, or between the lines within the same block.

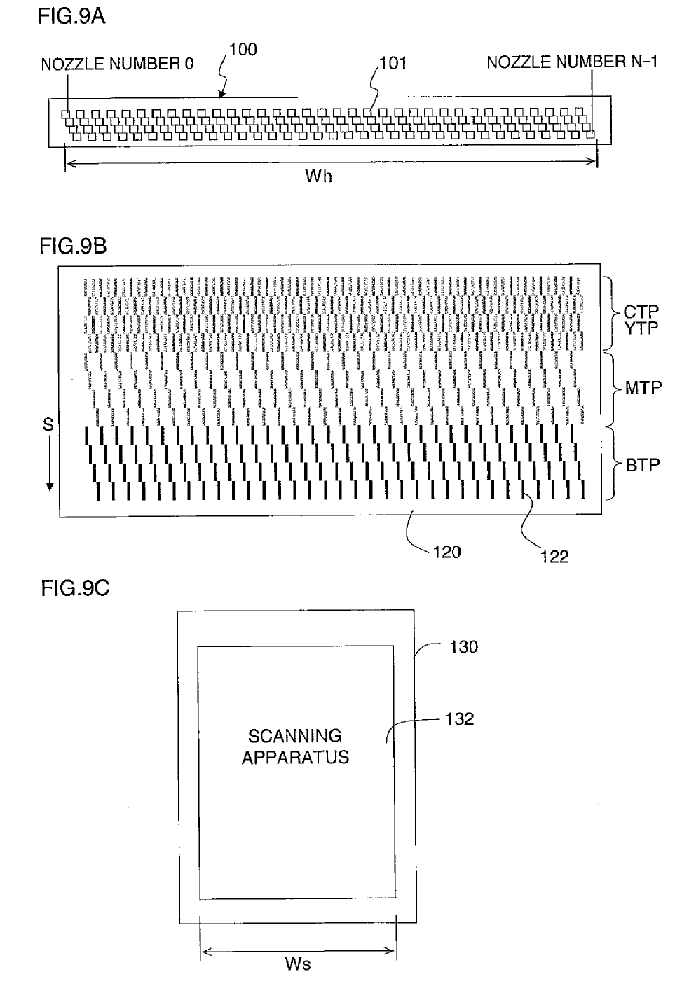

FIGS. 9A to 9C are diagrams showing the relationship between a test chart printed by a high-resolution broad-width line head and a scanning apparatus which reads in the test chart. More specifically, FIG. 9A is a schematic drawing of a line head 100, FIG. 9B is an example of a test chart 120 printed by the line head 100 shown in FIG. 9A, and FIG. 9C is a scanning apparatus 130 which reads in the test chart 120 shown in FIG. 9B. The surface area of the effective reading region 132 of the scanning apparatus 130 corresponds to an A4 size (297×210 mm), for example, and the image reading width Ws of the scanning apparatus 130 is smaller than the readable width Wh of the line head 100.

In FIG. 9A, in order to simplify the drawing, each nozzle 1001 of the line head 100 is depicted by a square shape, and the number of nozzles depicted is reduced in comparison with FIG. 5. As described with reference to FIG. 5, in a matrix head in which a plurality of nozzles are arranged in a two-dimensional configuration, the group of nozzles which are arranged in a two-dimensional configuration can be treated as being substantially equivalent to a nozzle configuration in a single row, by considering the effective nozzle row formed by projecting the nozzles normally to a straight line in the main scanning direction. The respective nozzles 101 in the line head 100 are identified so as to preserve the arrangement sequence of the nozzles in this effective nozzle row by assigning nozzle numbers from left to right as shown in FIG. 9A. Taking the total number of nozzles to be N, then the nozzle numbers start at 0, and the last nozzle has a number of N−1.

Here, only one line head 100 is depicted, but as shown in FIG. 1, a head having a similar composition may be included in the inkjet recording apparatus 10 for each of the four colors of C, M, Y and K.

FIG. 9B is an example of a test chart including line patterns 122 for each nozzle produced by droplet ejection from the respective nozzles of the heads of the four colors (CMYK). The test chart 120 shown in FIG. 9B includes a test pattern BTP created by black (B) ink, a test pattern (MTP) created by magenta (M) ink, and test patterns (CTP, YTP) created by cyan (C) and yellow (Y) inks. Inks which have absolutely different peak wavelengths of spectrum absorption (such as cyan and yellow, or magenta and yellow), can be used to form line patterns in the gaps between the other ink, thereby making it possible to reduce the printing surface area of the test chart. The drawing shows an example in which the respective line patterns of the test pattern created by C ink (CTP) and the test pattern created by Y ink (YTP) are recorded in alternating positions (in an interleaved fashion) by staggering the nozzle numbers used, so as to prevent overlapping between the line patterns, in the same region of the recording paper. This can also be achieved in the case of a combination of M ink and Y ink. Of course, it is also possible to form respective test patterns of cyan ink and yellow ink, by using the colors respectively in separate regions, in a similar fashion to the black and magenta inks.

By using the method shown in FIG. 8, the test patterns of the respective colors are arranged in such a manner that there is no mutual overlap between the line patterns 122 formed by any of the nozzles in the respective heads.

A plurality of test patterns having different dot sizes may also be formed on one test chart. Moreover, a test pattern constituted of different inks may be formed, as shown in FIG. 9B. The mode of the test chart is not limited to the example in FIG. 9B, and various other modes are possible within a range that achieves the measurement objectives.

If test patterns for all of the nozzles are formed by using all of the nozzles 101 in a broad-width line head 100, as shown in the example in FIG. 9B, then in order to read in the whole of this test pattern in one operation, it is necessary to use a scanning apparatus having an image reading width which is equal to or greater than the recordable width Wh of the line head 100. However, a scanning apparatus of this kind is expensive. In order to be able to read an image with good accuracy over a broad range, the conveyance accuracy of the optical system and the carriage, and the amount of data stored in one scanning operation become very high indeed (for example, a reading resolution of 4800 dpi is required to read in a print resolution of 2400 dpi, and a reading resolution of 2400 dpi is required to read in a print resolution of 1200 dpi). Therefore, if it is possible to read in the image by means of a scanner of narrow width (A4 size), then the costs of the image reading apparatus and the image processing can be reduced substantially.

Therefore, in the present embodiment, the image is read in by using a scanning apparatus 130 having an image reading width Ws which is smaller than the recordable width Wh of the line head 100. The problems involved in using a scanning apparatus 130 having a narrow width of this kind, and the means for solving these problems, are as described below.

### First Mode

The first mode is one where the test chart is split up into a size which can be read by the scanning apparatus 130. In measuring the depositing position of the dots formed by droplets ejected from the broad-width line head 100 (including ejection failures), there exist the following problems when one test chart (which includes line patterns corresponding to all of the nozzles) is split into a plurality of test charts of narrow width.

(Problem 1) Determining the dot depositing positions between nozzles which span between a plurality of the split test charts. In other words, calculating (identifying) the depositing positions of all dots in a broad-width line head, from the dot depositing positions in the respective split test charts.

(Problem 2) Determining the dot depositing positions between nozzles which span between the split test charts, when there is an ejection failure in a nozzle (a nozzle known as a “reference nozzle”, which is commonly used (duplicated) in different test charts to provide a reference position) which spans between a plurality of split test charts. In other words, countermeasures for a case where a reference nozzle is suffering an ejection failure.

(Problem 3) Determining the dot depositing positions between nozzles which span between the split test charts, in cases where there is an ejection failure in either one of the line patterns created by a reference nozzle which spans between a plurality of the split test charts (in other words, when the reference nozzle has operated normally (no ejection failure) and has been able to form a line pattern when printing one test chart, but the reference nozzle has developed an ejection failure in the printing of the other test chart). In other words, countermeasures for a case where a reference nozzle operates normally in one test chart and suffers an ejection failure in another test chart.

The following means are employed in the present embodiment in respect of the problems 1 to 3 described above.

In respect of the problem 1, this problem can be solved by creating a test chart including line patterns (reference line pattern region) using the nozzles at either end of the breadthways direction of the split test charts, in an overlapping fashion, and using the nozzle positions within this overlapping region as a reference to calculate the positions within the test charts and the positions between the test charts. In short, the internal positions (relative positions) are determined in accordance with the positions of the reference line patterns on either side thereof.

In respect of the problem 2, this problem can be solved by including a plurality of nozzles in the overlapping nozzles described above so as to dramatically reduce the possibility (probability) of ejection failure occurring in all of the reference nozzles, and furthermore, by implementing processing for identifying an ejection failure nozzle position within a overlapping (duplicated) line pattern region whenever there is an ejection failure nozzle in this overlapping region (duplicated line pattern region), and excluding the identified ejection failure nozzle from the calculation of the reference positions.

In respect of the problem 3, this problem can be solved by comparing the normal nozzles or ejection failure nozzles in the overlapping (duplicated) line pattern region, between test charts which have duplicated line patterns produced by the common nozzles, identifying those nozzles suffering ejection failure in either or both of the test charts, and implementing processing to exclude nozzles suffering ejection failure in one or both of the test charts from the calculation of the reference positions (in other words, only using nozzles which are operating normally in both test charts for the calculation of the reference positions).

Concrete examples are described below.

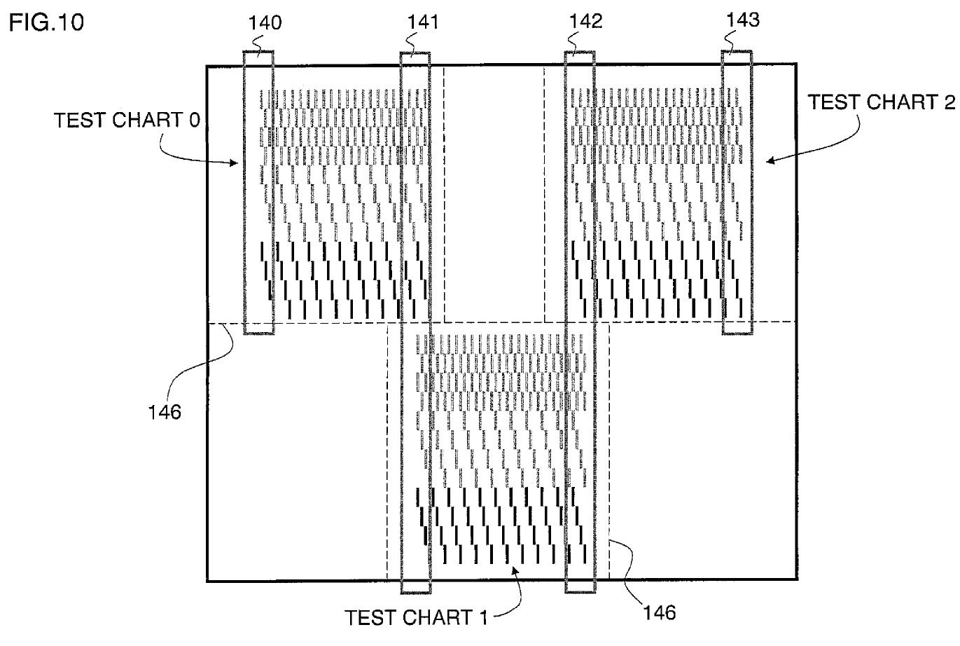

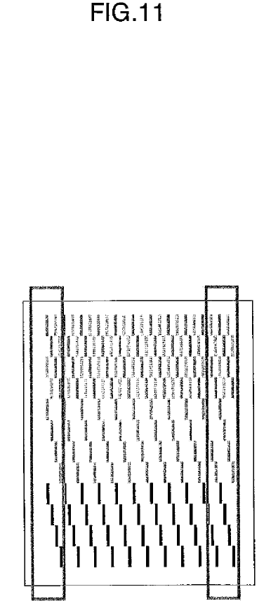

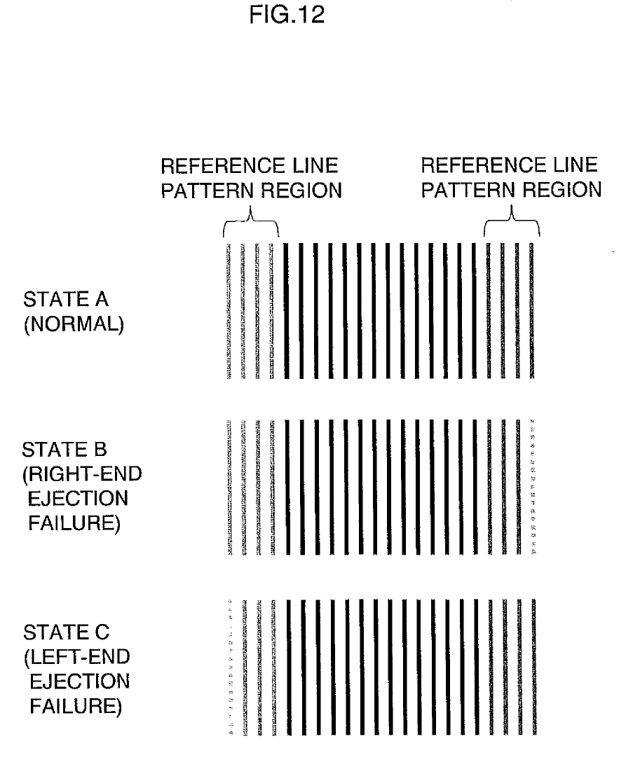

FIG. 10 is a diagram showing a first example of a test chart which is to be split up. As shown in FIG. 10, a test chart is formed by splitting into a plurality of regions in the breadthways direction. Each of the split regions corresponds to the envisaged image reading region which is covered in one scanning action by the scanning apparatus 130 (in this case, an A4-sized region). In order to identify the relative positions of the test charts in the respective split regions, a prescribed range (in the present embodiment, a range corresponding to the line patterns of four nozzles as enclosed by the thick line in FIG. 10) at both the left end portion and the right end portion of each split test chart is taken as a reference line pattern region (140, 141, 142, 143), and these reference line pattern regions are caused to overlap between the test charts which are mutually adjacent in the breadthways direction.

If only one nozzle is commonly used (duplicated) adjacent two of the test charts, then the positional determination accuracy falls markedly if an ejection failure occurs in this nozzle, and therefore it is desirable that a plurality of nozzles (consecutive nozzle numbers) should be commonly used in adjacent two of the test charts.

If the arrangement sequence numbers k of the split test charts are taken as 0, 1, 2, and so on, from the left-hand side in FIG. 10, then the plurality of nozzles which form the plurality of line patterns corresponding to the reference line pattern region on the right-hand side of the k-th split test chart coincide with the nozzles which form the line patterns of the reference line pattern region on the left-hand side of (k+1)-th test chart (k=0, 1, 2 and so on). A reference line pattern range which is overlapped between different test charts in this way is called an “overlapping (duplicated) line pattern region”. In other words, in FIG. 10, the regions indicated by the reference numerals 141 and 142 are overlapping (duplicated) line pattern regions (reference line pattern regions).

After printing a test chart containing line patterns created by all of the nozzles in this way on the recording paper, the test chart is divided up into a prescribed size which matches the reading size of the scanning apparatus 130, thereby creating a plurality of test chart strips (split test charts).

A desirable mode is one in which a cutoff line or a perforated line is formed to serve as a guide for splitting up the test chart, as indicated by the demarcation lines 146 shown by the dotted lines in FIG. 10, and another desirable mode is one which comprises a cutting device (cutter or the like) which automatically cuts the whole test chart to a prescribed size.

In this way, a plurality of split test charts (see FIG. 11) having a size and shape which is suited to reading in by the scanning apparatus 130 (the shape of the effective reading range 132, and a shape which substantially matches the surface area of same), are obtained. By using split test charts of this kind, it is possible to read in the test chart by carrying out one reading operation respectively for each of the split test charts. By reading in all of the plurality of split test charts and joining them together in the form of image data, it is possible to obtain information for a test pattern corresponding to all of the nozzles (information for the whole test chart before splitting).

### Arranging the Line Pattern Blocks in the Test Chart

As stated in relation to the problem 1, when the whole test chart is split up, there is a problem in determining the positions between nozzles which create line patterns in different split test charts. However, in the case of the present embodiment, the nozzles of a reference line pattern range are duplicated (overlapped) between the different test charts, and therefore it is possible to take these overlapped nozzles as references for calculating the positions between the test charts.

However, if one of the overlapped nozzles is suffering a defect (ejection failure) and is not able to form a line pattern, then even in a case where the number of overlapped nozzles is increased to a prescribed number (for example, four nozzles on the left-hand side and four nozzles on the right-hand side in one block), if an ejection failure occurs in the first nozzle (or the last nozzle), then it will not be possible to determine which nozzle within the overlapped nozzles is suffering an ejection failure.

To give a simple example, if the four nozzles on the left and right-hand sides of 100 nozzles are taken as overlapped nozzles, then if the leftmost nozzle is suffering an ejection failure, or if the rightmost nozzle is suffering an ejection failure, in both of these cases a similar line pattern block is obtained in which 99 line patterns are aligned, and therefore it is not possible to distinguish between these two cases.

Ultimately, this problem is a problem of the correspondence (identification) between the nozzle numbers used in the test pattern, and the dot positions read out from the test pattern.

In the line patterns in the inner part of the test pattern (the line patterns apart from the ends of the line pattern block), ejection failure nozzles (the absence of a line pattern that ought to be present) can be determined from the relationship between the standard line interval and the actually measured line interval.

However, if the line pattern at the endmost position (left-hand edge or right-hand edge) of the line pattern block is suffering an ejection failure, then it is difficult to identify whether this ejection failure is occurring at the left-hand edge or the right-hand edge. A similar situation occurs in the case of ejection failure occurring both at the endmost position and in the subsequent (adjacent) line pattern.

FIG. 12 is a diagram showing the above-described problem occurring in the event of an ejection failure at the end of a line pattern block. In FIG. 12, three states A to C are shown. The state A shown in FIG. 12 is a state of a normal line pattern block in which no ejection failure occur, and the state B shown in FIG. 12 is a state of a line pattern block in which an ejection failure occurs at the right-end of the line pattern block, and the state C in FIG. 12 is a state of a line pattern block in which an ejection failure occurs at the left-end of the line pattern block. If the actual test chart printing operation produces a line pattern block in which one line pattern is missing (there is one ejection failure nozzle), then it is not possible to distinguish between the state B and the state C shown in FIG. 12. Similarly, it is also impossible to distinguish between a case where two consecutive nozzles at one end are suffering ejection failures, and a case where the nozzles at either end are suffering ejection failure.

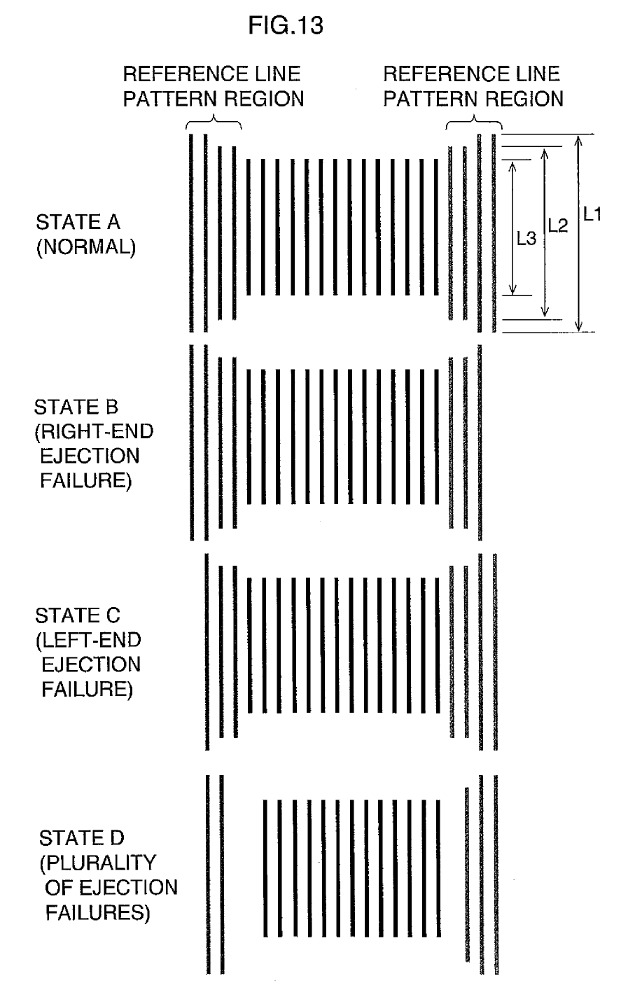

In the present embodiment, this problem is solved by altering the characteristic quantities of a prescribed number of line patterns at both the left-hand and right-hand ends of the split test charts, with respect to the other line patterns (see FIG. 13), when forming the line pattern blocks. This characteristic quantity may be the leading position of the line pattern (the line start position), the end position (the line end position), the length of the line pattern (line length), or the like.

Therefore, the problem described above is solved in this way by using a plurality of line patterns having mutually differentiated characteristic quantities, identifying the reference line patterns on the basis of the characteristic quantities, and then judging whether or not the number of reference nozzles is insufficient in comparison with the expected number of reference nozzles.

FIG. 13 is a diagram showing examples of line pattern blocks according to an embodiment of the present invention. In FIG. 13, four states A to D of the line pattern block, when a test chart (line pattern block) including line patterns having different characteristic quantities is recorded. The state A shown in FIG. 13 is a state of a normal line pattern block in which no ejection failure occurs. As shown in the state A of FIG. 13, the line patterns of four nozzles from both the left-hand and right-hand edges of the line pattern block are taken respectively as reference line pattern regions, and the line patterns of these four nozzles (called “reference line patterns”) are caused to overlap.

In other words, the reference line patterns are four consecutive lines respectively on the left-hand and right-hand sides, in which the lengths L1 and L2 (<L1) are used respectively for two lines each. Line patterns having a length L3 (<L2) (called “normal line patterns”) are formed by the other nozzles, in between the left-hand and right-hand reference line pattern regions (in the region interposed between the left-hand and right-hand reference line pattern regions). The relationship L3<L2<L1 is established in respect of the lengths of the line patterns, and the leading positions (upper end positions) of the lines and the end positions (lower end positions) of same also different in accordance with the respective lengths. In order to distinguish readily between these three lengths, L3 is denoted as “short”, L2 is denoted as “medium” and L1 is denoted as “long”.

The illustrated line pattern block has a total of 18 line patterns, comprising four lines of the reference line patterns at both the left-hand and right-hand sides, and ten lines of the normal line patterns arranged between the sets of reference line patterns.

FIG. 13 shows states B to D of line pattern blocks which are printed when an ejection failure has occurred in a portion of the nozzles, when using a line pattern block having the composition described above (the line pattern block same as the state A of FIG. 13). The state B shown in FIG. 13 is a state of a line pattern block in which an ejection failure occurs at the right-end of the line pattern block, the state C in FIG. 13 is a state of a line pattern block in which an ejection failure occurs at the left-end of the line pattern block, and the state D in FIG. 13 is a state of a line pattern block in which there are a plurality of ejection failures (a line pattern block in which a plurality of reference line patterns are suffering ejection failures).

If there are four reference line patterns respectively on the left-hand and right-hand sides, judgment is possible except in the case where all of these consecutive four nozzles are suffering ejection failure, but a case of this kind will be treated as a breakdown of the apparatus. The greater the number of the reference line patterns which are duplicated, the greater the reliability of the positional determination.

A line pattern block which is a print result of depositing droplets to form a line pattern block in a mode such as that shown in FIG. 13 is read in by the scanning apparatus 130.

### Method of Processing Read Image of Test Chart

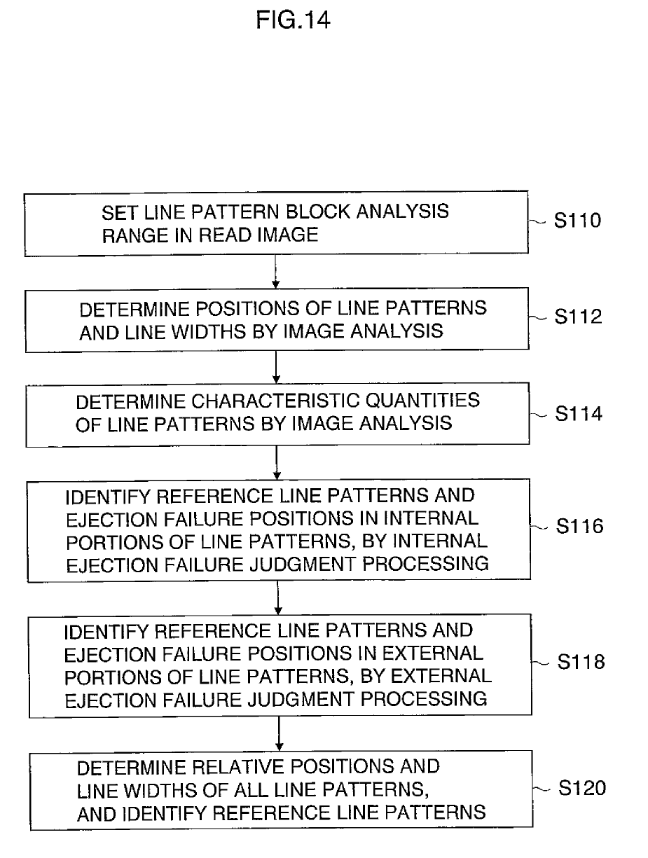

FIG. 14 is a flowchart showing the processing procedure (ejection failure judgment procedure) for the image which has been read in by the scanning apparatus 130.

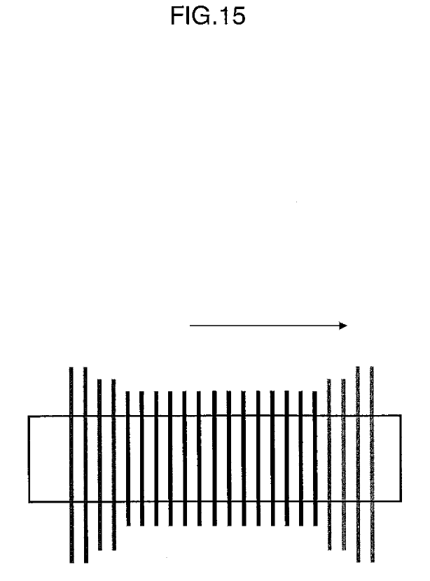

Firstly, the line pattern analysis range is set for the image obtained by the scanning apparatus 130 (read image) (step S110). For example, as shown in FIG. 15, a square range which includes the approximate central portion of all of the line patterns of the line pattern block under investigation (the range enclosed by the thick line in FIG. 15), is set as the line pattern block analysis range. For example, the analysis range is set by the following method.

### Example of Setting Line Pattern Block Analysis Range

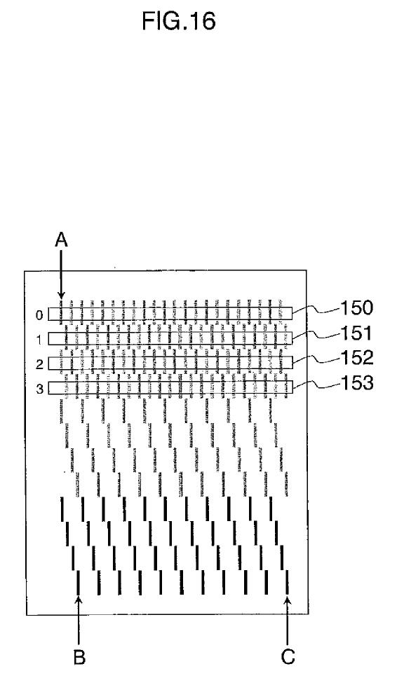

When the test chart reference position (A, B, C) is input manually by an operator (operating an input apparatus, such as a mouse or keyboard) while looking at a computer display of the image read in from one test chart, as shown in FIG. 16, then the line pattern block analysis ranges 150 to 153 are set for the respective line patterns on the basis of test chart layout information (information indicating the positional information of the respective analysis ranges for the line pattern blocks in the test chart, and information indicating the relative positions of the test chart reference positions).

When the image of the test chart is actually read in by the scanning apparatus 130, the image may move in parallel with respect to the standard reading position, or it may be displaced or skewed in position. In order to be able to achieve accurate measurement in cases of this kind, reference positions A to C are determined on the test chart. In FIG. 16, A is taken as the start position of the line pattern in the upper leftmost end of the test chart, B is taken as the end position of the lower leftmost line pattern, and C is taken as the end position of the lower rightmost line pattern. However, the method of determining the reference positions is not limited to this example. When the print area of the test chart is supposed to be a substantially rectangular shape, then it is desirable to arrange the reference positions at the corners of the rectangular shape of the print area.

After coordinates information for the three end points A, B, C of the test chart is input in this fashion, these can be compared with the ideal coordinates information for these three points according to the original design (the design information stored in the memory, or the like), and the angle of skew of the read image and the amount of parallel movement can be measured accordingly. The information corresponding to the skewed travel or parallel movement is amended (corrected) on the basis of this result, and the ranges to be analyzed (150 to 153) are set automatically. Of course, it is also possible to adopt a mode in which manual input by the operator is not required to determine the test chart reference positions by analyzing the images automatically.

### Contents of Image Analysis

In the line pattern block analysis range which has been set in this fashion, the image is analyzed by using a commonly known method (for example, it is possible to use the method described in “High Image Quality achieved through High Precision Measurement”, Howard Mizes; Xerox Corp.; Webster, N.Y., USA, 2006 Society for Imaging Science and Technology, p. 472 to p. 476), and the number of line patterns (np), the positional coordinates of the line patterns, position=(x0, x1, . . . , xnp−1), and the line width, width=(w0, w1, . . . , wnp−1) are calculated (step S112 in FIG. 14).

Next, the characteristic quantities of the respective line patterns are determined by image analysis, by taking the whole of the line pattern block as the analysis range (step S114). For example, the lengths of the respective lines are measured, and are classified into the three categories of “long”, “medium” and “short”.

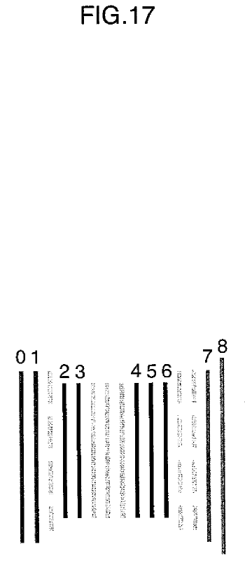

A simple example of this operation is now described with reference to FIG. 17. In normal circumstances (where there are no nozzles suffering ejection failure), the line pattern block shown in FIG. 17 has four reference line patterns (two consecutive lines of length L1 and two consecutive lines of length L2, as shown in the state A of FIG. 13) on the left-hand and right-hand sides, but here it is supposed that some of the line patterns are missing due to the presence of the ejection failure nozzles, and therefore in the read image of the line pattern block, only the nine (9) line patterns indicated by numbers 0 to 8 in FIG. 17 are observed. In FIG. 17, dashed lines indicate line patterns whose line length is unknown due to the ejection failure.

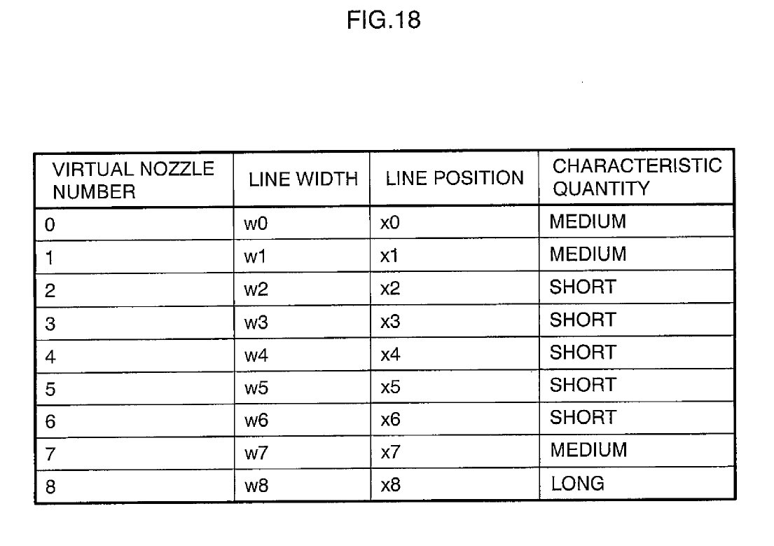

The information relating to the nine line patterns is handled as described below. Firstly, information such as that shown in the table in FIG. 18 is obtained by assigning virtual nozzle numbers from 0 to 8 sequentially to the nozzles from the left-hand end of the obtained line pattern block, and identifying the line width, line position and characteristic quantity (in this case, the length) of each of the line patterns. Below, the positions of the respective line patterns are described in terms of coordinates projected to a one-dimensional coordinates system.

### Internal Ejection Failure Judgment Processing

Next, processing is carried out for judging the presence of a line pattern suffering an ejection failure within the line pattern block (internal ejection failure judgment processing) on the basis of the information in FIG. 18 (step S116 in FIG. 14).

This processing involves, firstly, calculating the average pitch between the line patterns, ave_pitch, and comparing this average pitch value with the actually measured pitches between the respective lines.

The actually measured line pitch, pitch i, is determined by the following equation.

pitch i=xᵢ₊₁−xᵢ

The ratio Kᵢ between this value and the average pitch ave_pitch is determined as follows.

Kᵢ=pitch i/ave_pitch

Here, the value of the average pitch (i.e., ave_pitch) calculated from the actually measured line pitch (i.e., pitch i) is compared with a previously determined line pattern pitch, design_pitch, which was used to design the test pattern, and if the absolute value (i.e., d=|ave_pitch−design_pitch|/design_pitch) of the difference between same does not satisfy prescribed conditions, then the method of calculating Kᵢ is changed, ave_pitch is substituted, and Kᵢ is calculated by using design_pitch as follows: Kᵢ=pitch i/design_pitch. One example of a prescribed condition forming a judgment reference for changing the method of calculating Kᵢ, for example, is “d≦0.1”. However, the condition is not limited to this example, and it may be decided appropriately in accordance with the level of ejection failure occurring in the image forming apparatus.

The value IKᵢ is determined by rounding the obtained value of Kᵢ up or down to the nearest integer. If IKᵢ≧2, then it is considered that “IKᵢ−1” ejection failure nozzles are present between the virtual nozzle numbers i and i+1, and supposing that the respective positions of these ejection failure nozzles are distanced successively at intervals of “pitch i/IKᵢ” in the rightward direction with respect to xi, then the average value of width is assigned as the width of the respective lines, and a parameter “s” which indicates the status of the respective nozzles (=s0, s1, . . . , smp) is set to “ejection failure”.

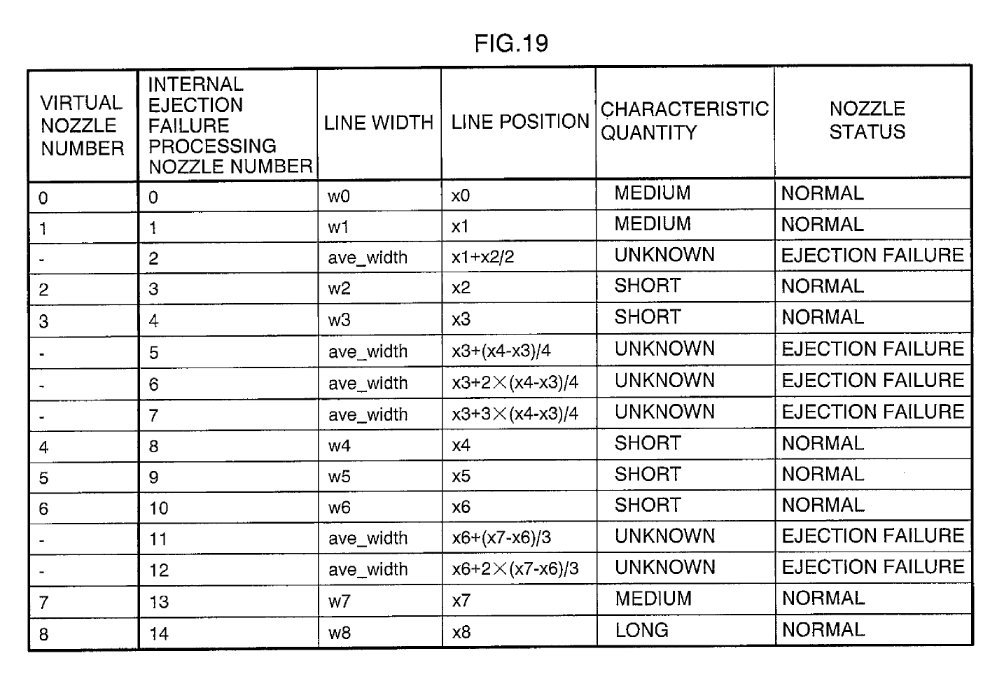

The “mp” value indicated here represents the total number of line patterns obtained by adding the number of ejection failure nozzles estimated to be present by the judging process described above, to the number of line patterns which have actually been observed (the nine lines in FIG. 17). In this way, information such as that shown in the table in FIG. 19 is obtained. The “internal ejection failure processing nozzle number” in FIG. 19 is a nozzle number which is reassigned to both the ejection failure nozzles estimated by the internal ejection failure judgment processing described above, and the nozzles which were assigned virtual nozzle numbers in FIG. 15. In FIG. 19, the correspondences between the virtual nozzle numbers from FIG. 15 and the “internal ejection failure processing nozzle numbers” are also indicated.

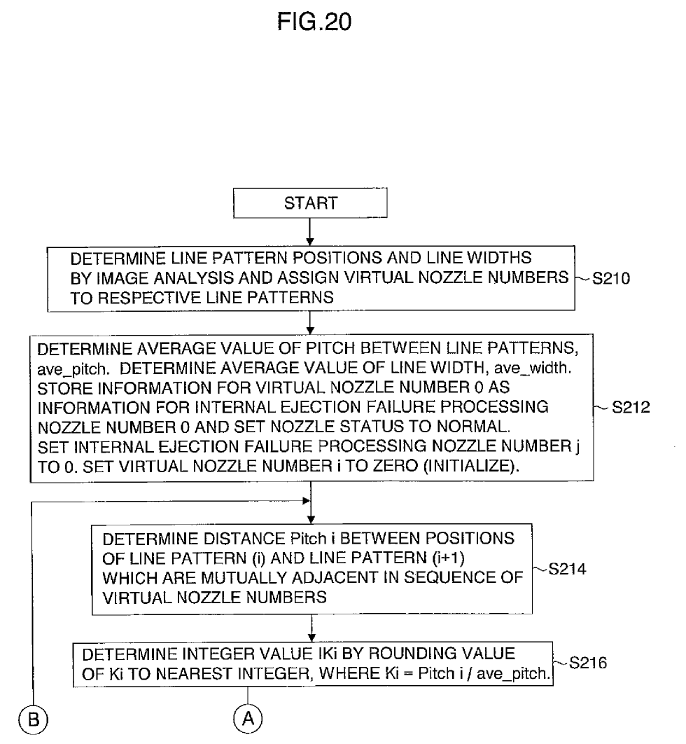

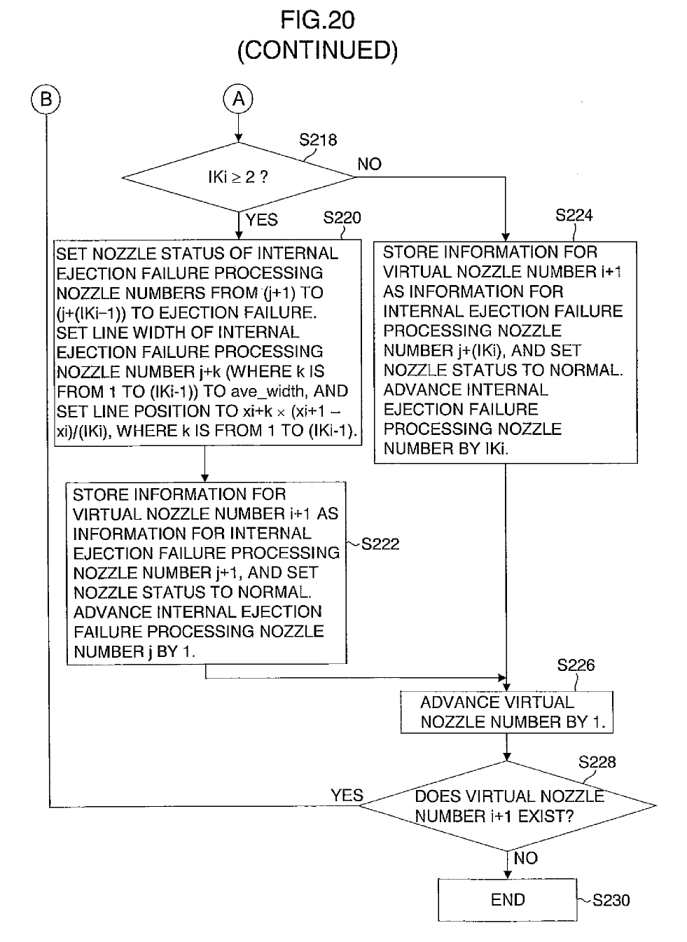

The details of this internal ejection failure judgment processing will now be described with reference to the flowchart in FIG. 20. Firstly, the line pattern position and line width are determined by image analysis of the line pattern block, and a virtual nozzle number is assigned to each line pattern (step S210). The concrete details are as described with reference to FIG. 14 (See. steps S110 to S114 in FIG. 14), and the information shown in the table in FIG. 18 is obtained.

Thereupon, the average value of the pitch between line patterns (i.e., ave_pitch) and the average line width (i.e.; ave_width) are determined on the basis of the information acquired at step S210 described above (step S212). Moreover, the information for the virtual nozzle number 0 is stored as information for the internal ejection failure processing nozzle number 0, and information indicating “normal” is stored as the nozzle status. The internal ejection failure processing nozzle number j is set to “0”. Furthermore, the virtual nozzle number i is set to zero (namely, it is initialized) (step S212).

Next, the distance (i.e., Pitch i) between the positions of the line pattern i and the line pattern i+1 which are mutually adjacent in the sequence of the virtual nozzle numbers is determined (step S214), and the ratio Kᵢ with respect to the average line width (i.e., ave_width) is determined and rounded up or down to the nearest integer to give an integral value of IKᵢ (step S216). It is then judged whether or not the value of IKᵢ is equal to or greater than two (step S218), and if the verdict is YES (IKᵢ≧2), then the procedure advances to step S220.

At step S220, the nozzle statuses from the internal ejection failure processing nozzle number j+1 until j+(IKᵢ−1) are judged to be “ejection failure”, and the line width of the internal ejection failure processing nozzle number j+k (where k is from 1 until (IKᵢ−1)) is stored as ave_width, and the line position is stored as xᵢ+k×(xᵢ₊₁−xᵢ)/(IKᵢ).

Furthermore, the information relating to the virtual nozzle number i+1 is stored as information for the internal ejection failure processing nozzle number j+(IKᵢ), and the nozzle status of that nozzle is set to “normal” (step S222). Thereupon, the internal ejection failure processing nozzle number j is advanced by IKi, and the procedure advances to step S226.

On the other hand, if the verdict is NO (IKi<2) in the judgment in step S218, the procedure advances to step S224, and the information for the virtual nozzle number i+1 is stored as information for the internal ejection failure processing nozzle number j+1, and the nozzle status is set to “normal”. Thereupon, the internal ejection failure processing nozzle number j is advanced by 1, and the procedure advances to step S226.

At step S226, the virtual nozzle number i is advanced by 1, and at the next execution of step S228, it is judged whether or not the incremented value (virtual nozzle number i+1) exists.

If the virtual nozzle number i+1 exists (YES at step S228), then the procedure returns to step S214, and the processing described above (steps S214 to S216) is repeated. On the other hand, if it is judged at step S228 that the virtual nozzle number i+1 does not exist (No verdict), then the processing terminates (step S230).

Information such as that shown in the table in FIG. 19 (internal ejection failure judgment processing information) is obtained by means of the processing sequence described above.

### External Ejection Failure Judgment Processing

After the internal ejection failure judgment processing, processing for judging external ejection failure nozzles and deducing reference line patterns is carried out (step S118 in FIG. 14). More specifically, external ejection failure nozzles are judged on the basis of the following information. In other words, as stated above, under normal circumstances, the reference line patterns are four lines on the left-hand side and the right-hand side, each set of four lines comprising two long lines and two medium lines which are formed consecutively. Furthermore, since the total number of line patterns including the reference line patterns is 18 lines, then the normal line patterns are 18−(4+4) 10 lines.

The internal ejection failure deduction nozzle numbers 0 and 1 relating to the left-hand side of the line pattern block are confirmed to be reference line patterns of “medium” length (two line patterns), on the basis of the information obtained from the internal ejection failure judgment processing (FIG. 19) described above.

Furthermore, the internal ejection failure deduction nozzle numbers 14 and 15 relating to the right-hand side are confirmed to be a “medium” reference line pattern and a “long” reference line pattern (two line patterns).

The total number of line patterns after the internal ejection failure judgment processing (the number of line patterns including the line patterns deduced to be ejection failure nozzle positions) is 15 lines, and of these, the line patterns confirmed to be “reference line patterns” are two lines on the left-hand side (two medium lines) and two lines on the right-hand side (one medium line and one long line). There are eight normal line patterns which are determined to have a “short” characteristic quantity. In this case, lines which are arranged between lines having a characteristic quantity of “short” are deduced to be “short” lines.

Consequently, the number of line patterns which are to be added as external ejection failure line patterns is 18 15=3 line patterns. These added three line patterns are all reference line patterns.

Since the left-hand side of the line pattern block has two reference line patterns (medium), then it can be ascertained that on the left-hand side there are two reference line patterns (long) which are suffering ejection failure (line patterns which are missing and should be added). On the other hand, on the right-hand side, it can be ascertained that there is one reference line pattern (long) which is suffering ejection failure (a line pattern which is missing and should be added).

When the external ejection failure nozzles have been identified in this way, it is determined that the “unknown” characteristic quantity of the internal ejection failure processing nozzle number 2 in FIG. 19 is a “short” normal line pattern, the “unknown” characteristic quantity of the internal ejection failure processing nozzle number 11 is a “short” normal line pattern, and the “unknown” characteristic quantity of the internal ejection failure processing nozzle number 12 is a “medium” reference line pattern.

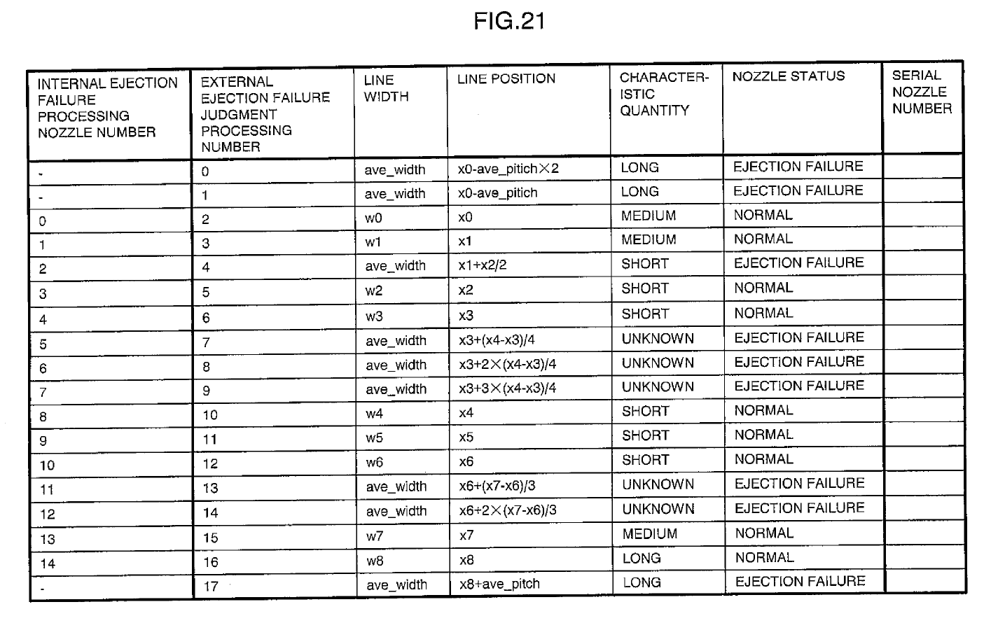

As a result of the external ejection failure judgment processing described above, the information shown in the table in FIG. 21 is obtained, and hence the positions and statuses of all of the nozzles, including the ejection failure nozzles, can be identified. The “nozzle number after external ejection failure processing” in FIG. 21 is a nozzle number which is reassigned to both the ejection failure nozzles identified by the external ejection failure judgment processing and the nozzles having internal ejection failure deduction nozzle numbers. FIG. 21 also indicates the correspondences between the “internal ejection failure processing nozzle numbers” in FIG. 19 and the “nozzle numbers after external ejection failure processing”.

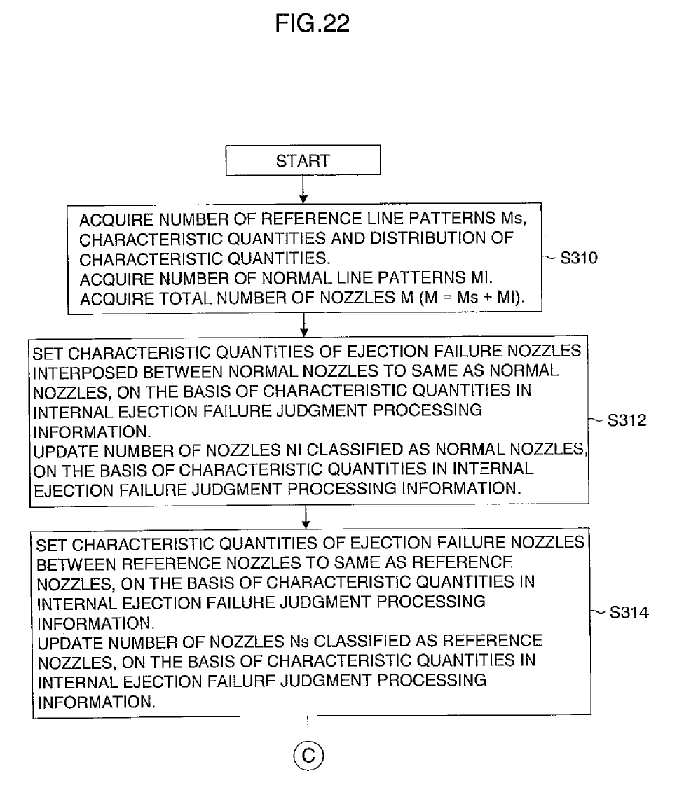

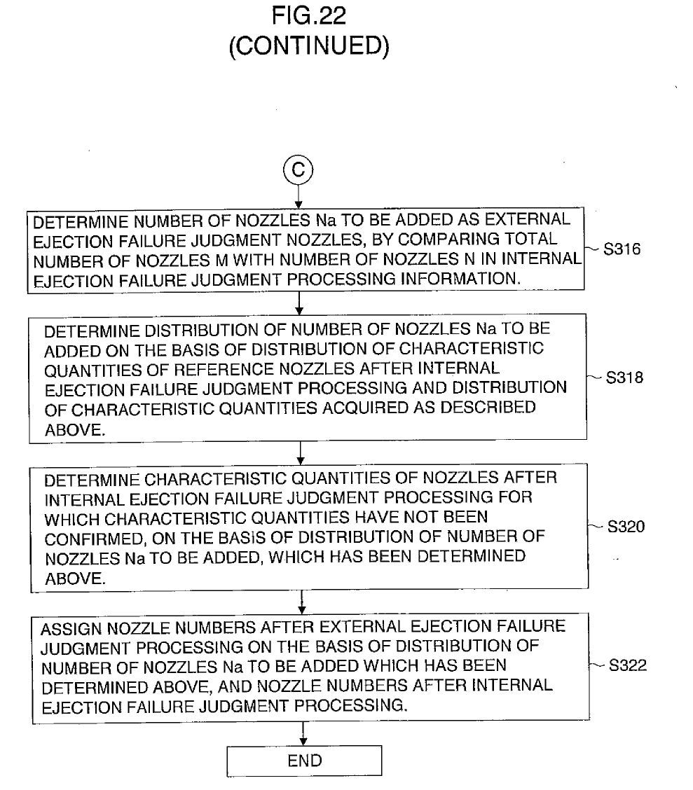

The details of this external ejection failure judgment processing will now be described with reference to the flowchart in FIG. 22. Firstly at step S310, the number Ms of reference line patterns in the line pattern block, and information relating to their characteristic quantities and the distribution of the characteristic quantities is acquired. Furthermore, information on the number of normal line patterns Ml is acquired, and the total number of nozzles M (M=Ms+Ml) is thereby obtained.

Next, at step S312, on the basis of the characteristic quantities in the internal ejection failure judgment processing information, the characteristic quantities of ejection failure nozzles which are arranged between normal nozzles (nozzles which form normal line patterns) are set to the same values as the normal nozzles, and the number Nl of normal nozzles (i.e., nozzles that are classified as normal nozzles on the basis of the characteristic quantities in the internal ejection failure judgment processing information) is updated.

Next, at step S314, on the basis of the characteristic quantities in the internal ejection failure judgment processing information, the characteristic quantities of ejection failure nozzles which are arranged between reference nozzles (nozzles which form reference line patterns) are set to the same values as the reference nozzles, and the number Ns of reference (i.e., nozzles that are classified as reference nozzles on the basis of the characteristic quantities in the internal ejection failure judgment processing information) is updated.

Next, the number Na of nozzles to be added as external ejection failure judgment nozzles is determined by finding the difference between the number of nozzles N in the internal ejection failure judgment processing information and the total number of nozzles M (step S316). The distribution of the number of nozzles Na to be added (the locations indicated by the characteristic quantities) is determined on the basis of the distribution of the characteristic quantities of the reference nozzles after the internal ejection failure judgment processing and the distribution of the characteristic quantities acquired at step S310 (step S318).

Next, the characteristic quantities of the nozzles after internal ejection failure judgment processing for which the characteristic quantities have not been confirmed, are determined from the distribution of the number of nozzles Na to be added, which was determined at step S318 (step S320).

The nozzle numbers after the external ejection failure judgment processing are then assigned on the basis of the distribution of the number of nozzles Na to be added and the nozzle numbers after internal ejection failure judgment processing (internal ejection failure processing nozzle numbers) which have been established in this way (step S322).

Information such as that shown in the table in FIG. 21 (external ejection failure judgment processing information) is obtained by means of the processing sequence described above.

The method of the ejection failure judgment processing described above is not limited to the example of the line pattern block shown in FIG. 16, and evidently, it may also be applied to various variations of line pattern blocks in terms of the concrete mode of the block, such as the number of reference line patterns, the combination of the characteristic quantities, and the number of normal line patterns, and so on. In other words, in a line pattern block which comprises a plurality of reference line patterns having different characteristic quantities, provided that the number of reference line patterns on the left and right-hand sides and the number of normal line patterns is known in advance, it is possible to deduce the relationship between all of the ejection failure positions and the corresponding nozzle numbers.

By arranging a plurality of reference line patterns having different characteristic quantities as described above at either end of each line pattern of each color in the split test charts, it is possible to determine all of the line patterns suffering ejection failure, in line pattern block units.

If there are a plurality of line pattern blocks in the test chart as described in the above example, then processing (namely, processing which uses a common reference line to calculate the positions between the line pattern blocks) is carried out to adjust for the positional error between the respective line pattern blocks at the image analysis step, and the ejection failures are then identified on the basis of the processing sequence described above.

### Processing for Correcting Positional Error Between Line Pattern Blocks

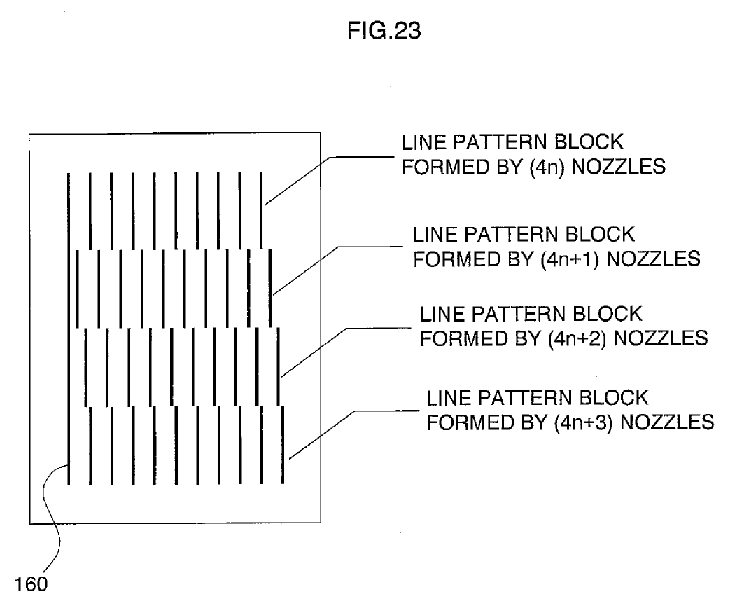

In order to adjust positional error between different line pattern blocks, it is preferable to use a test pattern having a composition such as that shown in FIGS. 23 to 25.

FIG. 23 is a diagram showing a test chart in which a line formed by a reference nozzle (the left-hand-most line in FIG. 23) is formed in all of the line pattern blocks. In other words, the test pattern shown in FIG. 23 contains a common line pattern (indicated by reference numeral 160) formed by a common nozzle, and the common line pattern 160 formed by the common nozzle is present in all of the line pattern blocks.

It is possible to reduce the error by moving all of the nozzle positions belonging to each block, in parallel, on a common base line, “Common Base Line” (which corresponds to a straight line of a one-dimensional coordinates system to which the positions of the respective line patterns are projected), in such a manner that the positions of the common line patterns in the blocks coincide with each other.

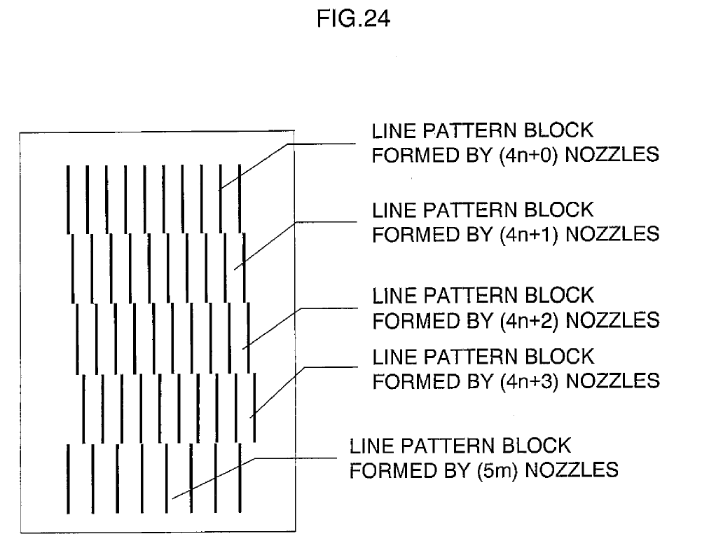

FIG. 24 is a further example of a measurement pattern which takes account of the correction of positional error between blocks. In FIG. 24, a line pattern block created by nozzles having a nozzle number 5m (where m is an integer equal to or greater than 0) is formed below (after) the line pattern block formed by nozzles having a nozzle number of 4n+3 (remainder=3). The nozzles belonging to the group 5m also include nozzles having the nozzle numbers 4n, 4n+1, 4n+2, 4n+3. In other words, the respective lines m=0, 1, 2, 3, in the line pattern block created by the 5m nozzles are recorded respectively by the same nozzles as the nozzles 4n (n=0), 4n+1 (n=1), 4n+2 (n=2), 4n+3 (n=3) (the same applies to cases where m is not less than 4).

Therefore, it is possible to align the coordinate positions determined in each block, on the basis of the respective line positions in the 5m block. In the example described here, a line pattern created by the 5m nozzles is appended, but the nozzle numbers are not limited to multiples of 5 and a similar approach may be adopted using any integer other than multiples of 4. In other words, this same approach can be adopted provided that there are nozzle numbers which are common multiples.

In FIG. 24, the nozzle positions belonging to the block corresponding to the nozzle numbers 5m (where m=0, 1, 2, 3, . . . ) are taken to be correct positions, and these positions are used when correcting the nozzle positions of the other blocks so as to match the nozzle positions belonging to the block 5m.

A concrete example of this positional correction method is described below.

The line pattern block 5m shown at the bottom of FIG. 24 includes the nozzles numbered 0, 5, 10, 15, 20 . . . . For example, looking in particular at the 21st nozzle position, this nozzle “21” belongs to the block (4n+1). The nozzles numbered 5 and 25 which belong to both block 5m and block (4n+1) and which are disposed on either side of “21” are identified, and a parallel movement parameter is determined so as to match the nozzle 5 position in the 4n+1 block is determined, as well as a parameter for extending the distance between the nozzle S position and the nozzle 25 position so as to match the nozzle 25 position in the 4n+1 block. In this way, the nozzle 5 position and the nozzle 25 position in block 4n+1 are made to match the positions of nozzle 5 and nozzle 25 in the block 5m. The position of the nozzle number 21 is corrected by using the parallel movement parameter and the extending parameter.

In other words, if the dot position created by nozzle S and belonging to block 5m, is denoted as “P5@5m”, the position created by nozzle 25 and belonging to block 5m, is denoted as “P25@5m”, the position created by nozzle 5 and belonging to block (4n+1), is denoted as “P5@(4n+1)” and the position created by nozzle 25 and belonging to block (4n+1) is denoted as “P25@(4n+1)”, then the values are corrected by means of the following expressions.

(output)=COEFA×{(input value)−P5@(4n+1)}+COEFB

COFFA(P25@5n−P5@5n)/(P25@(4n+1)−P5@(4n+1))

COEFB=P5@5n.

If it is not possible to find nozzle positions belonging to common blocks which are disposed on either side as described above, then correction is carried out using the same correction parameters as the nearest position which belongs to common blocks. For example, correction is performed for nozzle number 1 (which belongs to the 4n+1 block) in the same fashion as if it were positioned between the nozzle numbers 5 and 25, which are the closest nozzles belonging to common blocks.

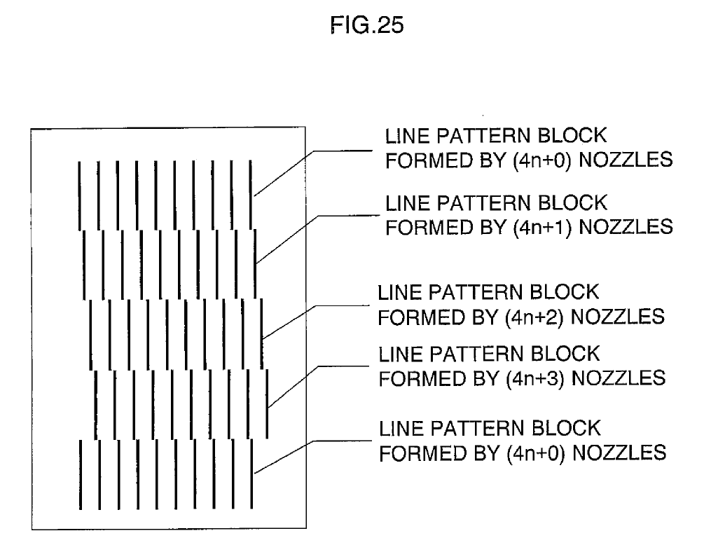

FIG. 25 is an example of a further measurement pattern which takes account of the correction of positional error between blocks.

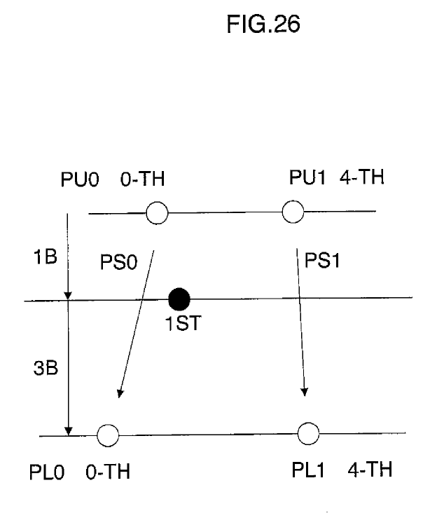

FIG. 25 shows an example where the nozzle positions belonging to blocks which are disposed between reference blocks (in FIG. 26, 4n blocks) are corrected on the basis of variation in the reference blocks.

In FIG. 25, the same block as the block (4n) at one end of the sample chart is formed at the other end (the bottommost part of the FIG. 26). By means of this composition, it is possible to identify the variation in the positional relationship of the same nozzle, between the upper and lower versions of the same block (4n), and the variation in the positional relationship thus identified can be reflected in the blocks (4n+1, 4n+2, 4n+3) which are disposed between the two blocks (4n).

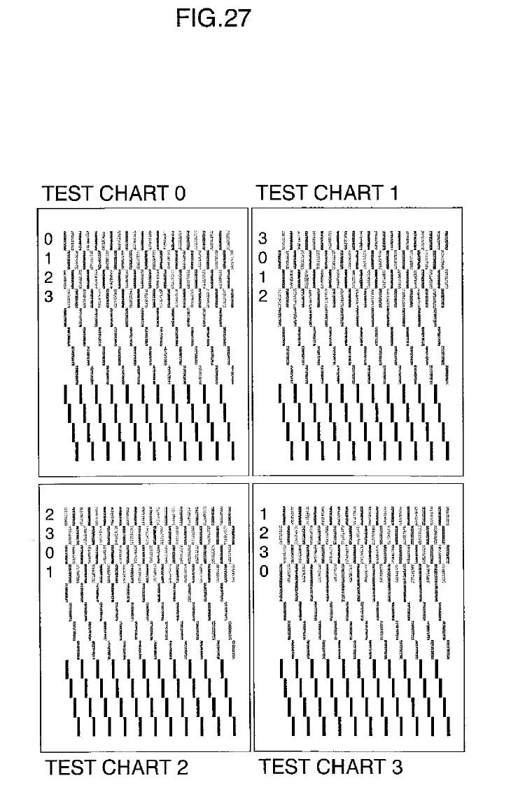

In FIG. 26, the distance in the Y direction between the position Uᵢ of the 4n block in the upper part and the position Lᵢ of the 4n block in the lower part is taken to be 4B, and the distance in the Y direction one block and the next block is taken to be B. Here, taking nozzle number 1 as an example, as shown in FIG. 27, the nozzle number 0 and the nozzle number 4 belonging block 4n, which are disposed on either side of the nozzle number 1, are converted from upper 4n block to lower 4n block in the following manner from the positions PU0 and PU1 in the upper end block, to the positions PL0, PL1 in the lower end block, via the block 4n+1 to which the nozzle number 1 belongs.

(output value)=COEFS×{(input value)−PU0}+COEFT

COEFS=(PL1−PL0)/(PU1−PU0), and

COEFT=PL0

As shown in FIG. 27, the distance in the Y direction from the upper 4n block to the lower 4n block is 4B, whereas the distance from the 4n+1 block to the lower block is 3B, and therefore the following correction formula is used to correct the position of the nozzle number 1.

(output value)=COEFS×{(input value)−PU0)}+COEFT

COEFS=(PS1−PS0)/(PU1−PU0)

COEFT=PL0

PS0=PL0+(PU0−PL0)×¾

PS1=PL1+(PU1−PL1)×¾

If positions on either side of the position under investigation do not exist, then the nearest nozzle numbers of the group 4n are used and the correction formula between these two nozzles is applied.

By means of this method, it is possible to correct the positional error occurring between the plurality of line pattern blocks.

As indicated by the flowchart in FIG. 14 (steps S110 to S118) and the flowchart in FIG. 20 and FIG. 22, in each of the individual line pattern blocks of the test pattern, it is possible to identify the nozzle positions within the block (relative positions of the line patterns), the line widths, and the reference line patterns, by means of internal ejection failure judgment processing and external ejection failure judgment processing. Therefore, by carrying out similar processing in respect of a plurality of line pattern blocks (which have been corrected in respect of positional error), it is possible to identify all of the nozzle positions (the relative positions of the line patterns including the positions of ejection failures), the line widths, and the reference line patterns which are contained in the one test pattern (step S120 in FIG. 14).

### Identification of Test Pattern

The split test chart read in by the scanning apparatus 130 is identified in respect of which portion of the whole test chart it constitutes (namely, it is categorized into one of the test chart 0 to 3) by means of an instruction (input) by the operator, if the operator is able to recognize same. Alternatively, the test pattern may be identified automatically by using the nozzle sequence information used in each of the line pattern blocks, as described below.

When the sheets of the split test charts are handled individually in the form of the test charts 0, 1, 2, . . . shown in FIG. 10 and FIG. 11, the relationships between the read test chart object and the corresponding test chart may become confusing.

If it is not possible to identify accurately which portion within the whole test chart the test chart corresponding to the read object belongs to, then it is not possible to determine the dot positions of the whole test chart correctly. This problem can be avoided by forming visible information (for example, text, numerals, symbols, etc.) for identifying the test chart, on each of the test charts, in such a manner that the operator does not mistake the order of the test charts during their handling.

Possible examples of identification methods based on incorporating information identifying the plurality of charts into each chart are a mode where a number (which may be marked on the test chart in the form of a number or barcode) indicating the corresponding portion of the set of the plurality of charts is applied, or a mode where the arrangement of the actual line patterns (the sequence of the remainder value of the nozzle number) is altered. Moreover, there is also a mode which uses information to prevent confusion between one set of a plurality of charts and a different set of charts (information such as the date of creation, the serial number, unique number, etc.)

The method of identifying the test chart by means of the arrangement of the actual line patterns is described now with reference to a concrete example.

For example, it is supposed that the total number of nozzles in a line head is 4096 (nozzle numbers 0 to 4095), and that the test chart is split into four test charts (numbers 0 to 3). The split test chart 0 is created using the nozzle numbers 0 to 1039, and the arrangement sequence of the respective line pattern blocks is set to the sequence of 0, 1, 2, 3 of the remainder value obtained by dividing the nozzle number by 4 (See FIG. 27). The nozzle numbers 1024 to 1039 form the line patterns (reference line patterns) which are duplicated with the next test chart 1. The line pattern blocks are individually formed for the remainder values of 0, 1, 2 and 3, respectively, and in each of the line pattern blocks, there are four lines forming the reference line patterns.

The test chart 1 is created using the nozzle numbers 1024 to 2063, and the arrangement sequence of the line pattern blocks is based on the order of remainder value 3, 0, 1, 2. The nozzle numbers 2048 to 2063 form line patterns which are duplicated with the next test chart 2.

The test chart 2 is created using the nozzle numbers 2048 to 3087, and the arrangement sequence of the line pattern blocks is based on the order of remainder value 2, 3, 0, 1. The nozzle numbers 3072 to 3087 form line patterns which are duplicated with the next test chart 3.

The test chart 3 is created using the nozzle numbers 3072 to 4095, and the arrangement sequence of the line pattern blocks is based on the order of remainder value 1, 2, 3, 0.

By this means, four test charts 0 to 3 such as those shown in FIG. 27 are obtained. Since the test patterns in the respective test charts 0 to 3 have different arrangement sequences of the line pattern blocks, then it is possible to identify the test patterns on the basis of the information relating to this arrangement sequences of the line pattern blocks.

In other words, in the test pattern which has line pattern blocks arranged in regular fashion as shown in FIG. 27 for each R value of the nozzle number 4N+R (where N is an integer equal to or greater than zero, and R is one of 0, 1, 2 and 3), the arrangement sequence of the line pattern blocks (the arrangement sequence of the remainder value R) is altered between each of the test charts. Therefore, when the test chart is read in, it can be classified as one of the four cases described above, on the basis of the relative positions of the line patterns belonging to each block.

If it is decided in advance which case of the four cases corresponds to each number of the test charts, then it will be possible to identify the test chart that has been read in.

Since the number of possible arrangement sequences of the four blocks is permutation of four, then a total of 4!=24 test charts can be identified. Although 24 cases can be identified for one ink as described above, by combining this with the positions of the blocks for each ink (the three positions in the example in FIG. 27), further 3!=6 cases are possible. Therefore, in combination with the type of ink, 24×6=144 different types of test charts can be identified at maximum.

If there are 8 blocks or 16 blocks, then it is possible to identify (classify) an even greater number of cases, and therefore it is also possible to distinguish between test charts having different test chart creation timings by varying the combination of blocks used in accordance with the cumulative total number of output test charts. For example, by changing the combination of blocks on the basis of the creation date and time of the test chart, it is possible to distinguish between sets having different creation times.

In the method for identifying test charts on the basis of the arrangement sequence of the line pattern blocks, since the line patterns themselves function as identification information, there is no need to add separate identification information for the purposes of identification, and hence a merit is obtained in that an area for displaying identification information is not required outside the printing area of the line patterns.

Furthermore, it is possible to identify the arrangement sequence of the line pattern blocks automatically by analyzing the image obtained by reading in the test chart, and this helps to avoid error by the operator. This can be achieved by including information for identifying a plurality of charts.

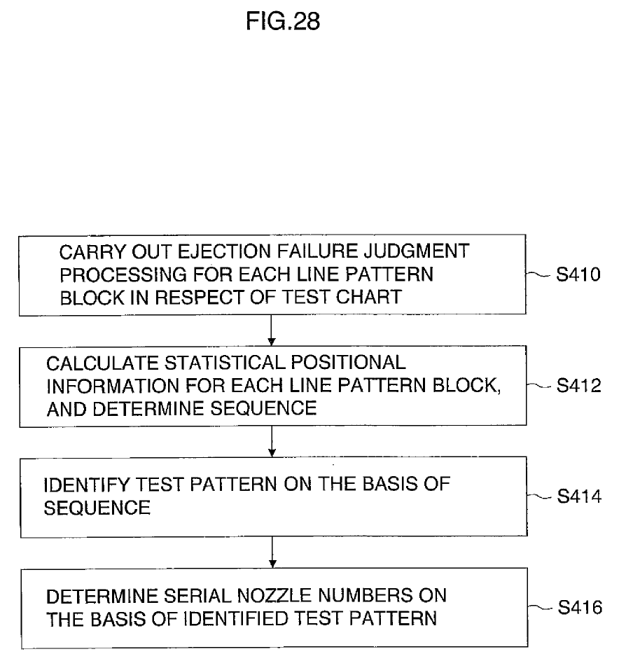

FIG. 28 is a flowchart showing the sequence of processing for identifying a test pattern. Firstly, ejection failure judgment processing for each line pattern block (the internal ejection failure judgment processing and external ejection failure judgment processing described above) is carried out with respect to the test chart (step S410).

Thereupon, the statistical positional information for each line pattern block is calculated and the arrangement sequence of the remainder value is determined (step S412). The test pattern is identified on the basis of the arrangement sequence, in accordance with previously established correspondence information (step S414), and the serial nozzle number is determined from the identified test pattern (step S416). In this way, the test pattern read in is identified automatically and by associating same with the nozzle number range of the test pattern, serial nozzle numbers are assigned (allocated) to all of the nozzles.

For example, if the test chart is split into four test charts 0 to 3 and the total number of nozzles is 4096, as described above, then when one test chart has been read in and the ejection failure judgment processing (the internal ejection failure judgment processing and external ejection failure judgment processing) has been completed for each of the line pattern blocks therein to obtain the information shown in FIG. 21, then it is possible to identify the test pattern by comparing the left-hand edge positions of each line pattern block. In other words, the test pattern can be identified depending on whether the alignment sequence of the left-hand edge positions is the order of remainder values of 0, 1, 2 and 3, or the order of the remainder values of 3, 0, 1 and 2 (see FIG. 27), for example. If the nozzle numbers used to form the line pattern blocks corresponds to the remainder values 0, 1, 2 and 3 of multiples of four, then when the left-hand edge positions are aligned for each respective line pattern block, these line pattern blocks respectively correspond to the remainder values of 0, 1, 2 and 3. This comparison may also be carried out at the right-hand edge, or an average position of the line patterns contained in the line pattern block, rather than at the left-hand edge.

When the nozzle number range has been identified by an instruction (input) from the operator, or by identification of the test pattern, then “serial nozzle numbers” which are nozzle numbers that are consecutive in respect of all of the nozzles are attached to the line pattern block information shown in FIG. 21 which is created for each line pattern block (namely, a particular serial nozzle number is assigned to each of the cells indicated in the rightmost column in the table in FIG. 21).

For example, in the case of test pattern 1, if the nozzle range is nozzle 1024 to nozzle 2047, then the serial nozzle numbers (from 1024 to 2047) can be assigned to the respective line pattern block information (the nozzle numbers after external ejection failure judgment).

The serial nozzle numbers and the relative positional information of the test patterns (respective line pattern blocks) contained in the test chart are determined as described above.

### Determining the Absolute Positional Information for all of the Nozzles

After determining the aforementioned information in respect of all of the test patterns (the plurality of split test patterns), positional information (absolute positions) which is consecutive in respect of all of the nozzles is determined. In an example where the test charts 0 to 3 are created by a line head having nozzle numbers 0 to 4095, when the serial nozzle numbers of the test patterns (the line patterns) contained in the test charts 0 to 3 and the relative positional information has been determined, the position of the nozzle number “0” is set to absolute position 0, and the absolute positions of the respective test patterns included in test chart 0 are determined successively on the basis of the relative positions of the test patterns in the test chart 0. More specifically, the relative position of the nozzle number 0 is subtracted from the respective relative positions.

Next, the nozzle status contained in the test chart 0 and the nozzle status contained in the test chart 1 are compared in respect of the nozzle numbers which are commonly used (duplicated) in test chart 0 and test chart 1 (the nozzle numbers 1024 to 1039), and the average value of the absolute positions is calculated in respect of test chart 0, only for those nozzles which are normal in both sets of information.

The average value of the relative positions is then calculated for test chart 1. The absolute positions are calculated on the basis of the relative positions of the test charts contained in test chart 1, in such a manner that the two average values coincide. More specifically, a shift value is determined on the basis of the following equation, by subtracting the average value of the relative positions of the duplicated nozzles in test chart 4, from the average value of the absolute positions of the duplicated nozzles in test chart 0.

Shift amount=Ave0−Ave1,

where Ave 0 is an average value of absolute positions of duplicated nozzles in test chart 0, and Ave 1 is an average value of relative positions of duplicated nozzles in test chart 1.

This shift amount is added to the relative positions at the respective nozzle numbers.

Thereupon, since there are two absolute positions of the nozzle numbers which are commonly used (duplicated) in both test chart 0 and test chart 1, then the average value of the two absolute positions is determined as the true absolute position.

In this way, the information relating to the positions which span test chart 0 and test chart 1 is linked together. Thereupon, similar processing to the foregoing is carried out in respect of the nozzle numbers which are commonly used in the test chart 1 and the test chart 2 (nozzle numbers 2048 to 2063) (further description of this processing is omitted here). Moreover, after this, similar processing is carried out in respect of the nozzle numbers which are commonly used in the test chart 2 and the test chart 3 (nozzle numbers 3072 to 3087).

By means of the procedure described above, all of the information relating to the line pattern blocks in the plurality of split test charts 0 to 3 is updated to positional information referenced to the absolute position “0” (namely, the information is mapped to a common one-dimensional coordinates system).

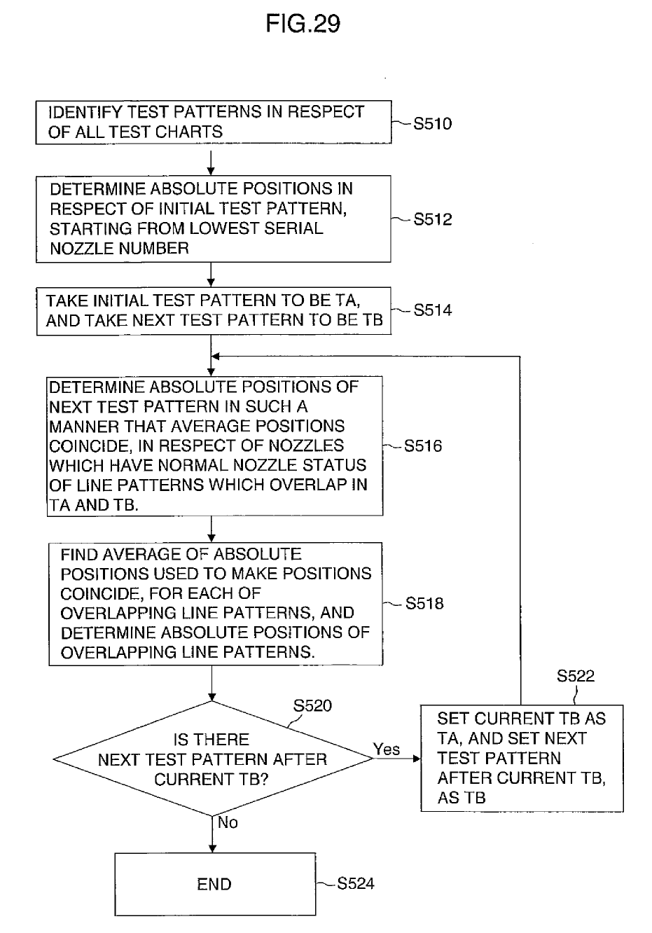

FIG. 29 is a flowchart of processing for determining absolute position information for all of the nozzles as described above.

Firstly, a test pattern identification process is carried out in respect of all of the test charts (step S510). The absolute positions are then determined in respect of the initial test pattern which includes the serial nozzle number 0, successively, starting from the lowest serial nozzle number in that test pattern (step S512). Taking the initial test pattern to be TA and the next test pattern to be TB (step S514), the absolute positions of the next test pattern are determined in such a manner that the average positions coincide in respect of the nozzles having a “normal” nozzle state (a state which is not subjected to ejection failure, and so on) of the reference line patterns which are duplicated in TA and TB (step S516).

Next, the absolute positions of the duplicated line patterns are determined by finding the average, for each of the duplicated line patterns, of the absolute positions which were used to make the aforementioned average positions coincide (step S518). Thereupon, the absolute positions of the respective serial nozzle numbers in TB are determined.

Once the absolute positions of each nozzle in TB have been obtained, the procedure advances to step S520, and it is judged whether or not there exists a subsequent test pattern in the current TB.

If there is a subsequent test pattern (YES) at step S520, then the current TB is taken as TA, the next test pattern of the current TB is set newly as TB (step S522), and the procedure returns to step S516 where the processing described above (steps S516 to S520) is repeated. In this way, absolute position information is obtained progressively for all of the test patterns. When the absolute position information for all of the test patterns has been established, then a “NO” verdict is obtained at step S520, and this process terminates (step S524).

In this way, positional information for each of the nozzles is obtained, as well as the respective nozzle statuses and line width information.

### Overall Processing Algorithm

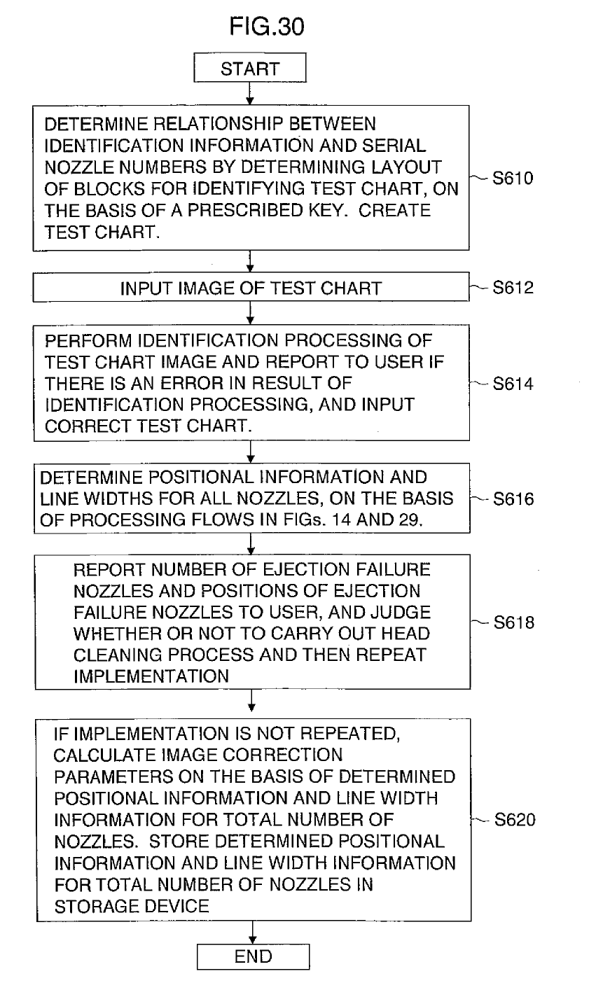

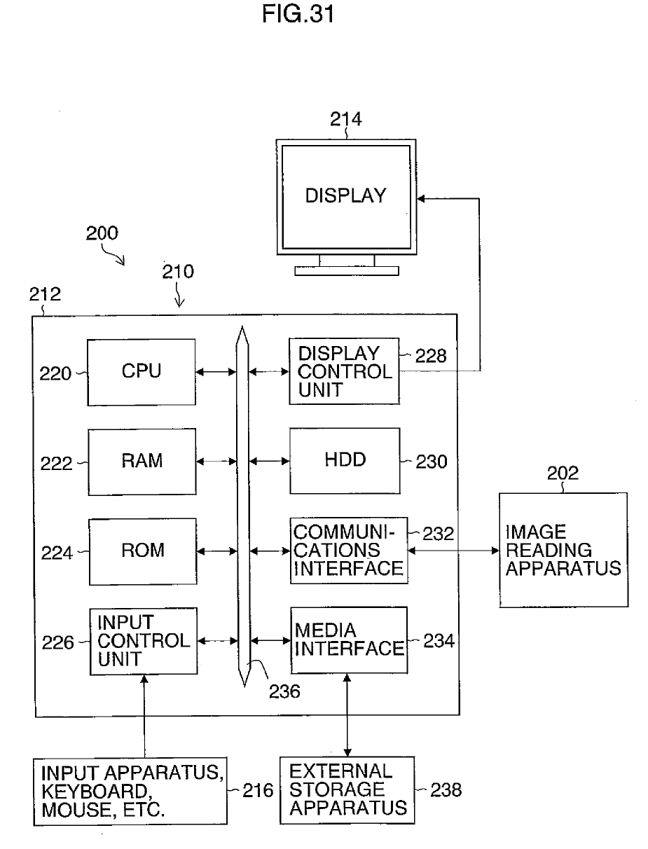

Next, the overall processing algorithm after the test charts have been created until the test charts are read in by means of a user interface is described with reference to the flowchart in FIG. 30.

Firstly, the block layout for test chart identification is determined on the basis of a prescribed key input performed by the user (operator), and the relationship between this identification information and the serial nozzle numbers is established (step S610). When prescribed information, such as the creation date and time or the chart title (unique number) has been input by the operator, the block arrangement sequence, and the like, is selected automatically on the basis of the input information and the accumulated past information, etc., and data for droplet ejection which is required for printing a test chart is generated, as well as creating information indicating the correspondences with the nozzle number ranges used in each of the split test charts. This information is stored in a memory which serves as a storage device. A test chart is printed on the basis of the droplet ejection data for printing the test chart determined in the above-described manner.

Thereupon, the image of the test chart obtained as described above is read in by the scanning apparatus 130, and the test chart image is supplied to a computer (step S612).

The computer carries out identification processing on the input test chart image, and if the identification process produces an error, then a corresponding message is issued to the user and a prompt for input of the correct test chart is displayed (step S614). If one set of test charts has been input correctly, then calculation for determining the positional information and line width for all the nozzles is carried out on the basis of a processing sequence which includes the ejection failure judgment processing (FIG. 14) and the processing for determining the absolute position information for all of the nozzles (FIG. 29) described previously (step S616).

From these calculation results, the number of ejection failure nozzles and the positions of the ejection failure nozzles are reported to the user, and the user is required to judge whether or not to carry out a head cleaning process and then repeat the implementation of the aforementioned procedure (step S618). If the user judges that the number of ejection failure nozzles and the ejection failure nozzle positions lie outside the tolerable range, then he or she inputs an instruction for “head cleaning and rerun of measurement process”, and accordingly, a prescribed head cleaning operation (an operation for restoring the ejection capability of the nozzles, such as nozzle suctioning, wiping of nozzle surface, preliminary ejection, or the like) is carried out. After the cleaning operation, a test chart is created again according to the procedure described above.

In this case, it is desirable to change the identification information so that this test chart can be distinguished from the previous test chart. A repeat measurement operation is then carried out in respect of the newly created test chart (steps S612 to 618). By previously setting, in the computer, standard conditions for the tolerable number of ejection failure nozzles and the positions of the ejection failure nozzles in relation to the report which is issued to the user in step S618, it is also possible to aid the user in his or her decision-making by, for instance, reporting information which indicates the need for repeat implementation to the user, and furthermore, it is also possible to omit the need for a decision by the user (in other words, it is possible to automate the judgment process).

On the other hand, if the measurement operation is not to be repeated, then image correction parameters are calculated on the basis of the positional information and the line widths which have been determined in respect of the total number of nozzles (step S620). The determined image correction parameter information, positional information for the total number of nozzles, and line width information are stored in the storage device, and the processing terminates.

### Example of Composition of Test Chart Measurement Apparatus

Next, an example of the composition of a test chart measurement apparatus which uses the test chart measurement method described above will be explained. A program is created which causes a computer to execute the image analysis processing algorithm used in the test chart measurement according to the present embodiment, and by running a computer on the basis of this program, it is possible to cause the computer to function as a calculating apparatus for the test chart measurement apparatus.

FIG. 31 is a block diagram showing an example of the composition of a test chart measurement apparatus. The test chart measurement apparatus 200 shown in FIG. 31 comprises a flatbed scanner which forms an image reading apparatus 202 (equivalent to the scanning apparatus 130 in FIG. 9C), and a computer 210 which performs calculations for image analysis, and the like.

The image reading apparatus 202 is provided with an RGB line sensor (a CCD imaging element or CMOS imaging element) which reads in the line patterns on the test chart, and also comprises a scanning mechanism which moves this line sensor in the reading scanning direction, a drive circuit of the line sensor, and a signal processing circuit, or the like, which converts the output signal from the sensor (image capture signal), from analog to digital, in order to obtain a digital image data of a prescribed format.

The computer 210 comprises a main body 212, a display (display device) 214, and input apparatuses, such as a keyboard and mouse (input devices for inputting various commands) 216. The main body 212 houses a central processing unit (CPU) 220, a RAM 222, a ROM 224, an input control unit 226 which controls the input of signals from the input apparatuses 216, a display control unit 228 which outputs display signals to the display 214, a hard disk apparatus 230, a communications interface 232, a media interface 234, and the like, and these respective circuits are mutually connected by means of a bus 236.

The CPU 220 functions as a general control apparatus and computing apparatus (computing device). The RAM 222 is used as a temporary data storage region, and as a work area during execution of the program by the CPU 220. The ROM 224 is a rewriteable non-volatile storage device which stores a boot program for operating the CPU 220, various settings values and network connection information, and the like. An operating system (OS) and various applicational software programs and data, and the like, are stored in the hard disk apparatus 230.

The communications interface 232 is a device for connecting to an external device or communications network, on the basis of a prescribed communications system, such as USB (Universal Serial Bus), LAN, Bluetooth (registered trademark), or the like. The media interface 234 is a device which controls the reading and writing of the external storage apparatus 238, which is typically a memory card, a magnetic disk, a magneto-optical disk, or an optical disk.

In the present embodiment, the image reading apparatus 202 and the computer 210 are connected via a communications interface 232, and the data of a captured image which is read in by the image reading apparatus 202 is input to the computer 210. A composition can be adopted in which the data of the captured image acquired by the image reading apparatus 202 is stored temporarily in the external storage apparatus 238, and the captured image data is input to the computer 210 via this external storage apparatus 238.

The image analysis processing program (including a program for the ejection failure judgment processing) used in the method of measuring the test chart according to an embodiment of the present invention is stored in the hard disk apparatus 230 or the external storage apparatus 238, and the program is read out, developed in the RAM 222 and executed, according to requirements. Alternatively, it is also possible to adopt a mode in which a program is supplied by a server situated on a network (not shown) which is connected via the communications interface 232, or a mode in which a computation processing service based on the program is supplied by a server based on the Internet.

The operator is able to input various initial values, by operating the input apparatus 216 while observing the application window (not shown) displayed on the display monitor 214, as well as being able to confirm the calculation results on the monitor 214.

Furthermore, the data resulting from the calculation operations (measurement results) can be stored in the external storage apparatus 238 or output externally via the communications interface 232. The information resulting from the measurement process is input to the inkjet recording apparatus via the communications interface 232 or the external storage apparatus 238.

The computer 210 is also able to serve as the host computer 86 which is shown in FIG. 6. Alternatively, it is also possible to adopt a composition in which calculational processing functions for dot measurement are incorporated into the system controller (reference numeral 72 in FIG. 6) and/or the print controller (reference numeral 80) of the inkjet recording apparatus 10, and the image data obtained from the image reading apparatus (scanning apparatus 130) is processed by the system controller in the inkjet recording apparatus (or by the system controller in combination with the print controller).

### Second Mode

In the first mode which was described above, the test chart is split (divided) into a size which can be read in by the scanning apparatus 130, but in the second mode, the whole of the test chart is read in the form of a single sheet (without splitting into a plurality of test charts), by successively changing the region which is read.

In this second mode, when measuring the depositing positions (including ejection failures) of the dots formed by droplets ejected by a broad-width line head, the following problems arise when a single test chart of large width is read in by a plurality of reading operations.

(Problem 4) Determining the range of the test chart which is to be read in by a plurality of operations (identification of overlapping (duplicated) line patterns (nozzles) and avoiding the skipping of line patterns (nozzles)).

(Problem 5) Calculating the nozzle positions in the whole broad-width head from the dot depositing positions obtained in each reading operation of the test chart.

(Problem 6) Determining the dot depositing positions when nozzles which are commonly used (duplicated) in the plurality of reading operations of the test chart are suffering an ejection failure.

Of the problems 4 to 6 described above, the problem 4 can be solved by causing the nozzles which correspond to the end portions of the respective reading operations of the test chart to create line patterns having characteristics which enable them to be identified readily by the operator and in the image analysis processing, in such a manner that the operator reads in the image by means of the scanner by causing these end portion nozzles to be duplicated (overlap) between a plurality of reading operations.

The problem 5 can be resolved by calculating the position within the test chart (duplicated line pattern region) and the position between test charts, with reference to the positions of overlapped nozzles.

The problem 6 can be resolved by using a plurality of nozzles as the overlapped nozzles (commonly used nozzles) so as to reduce the probability of ejection failure occurring in all of the overlapped nozzles, identifying ejection failure nozzle positions amongst the overlap nozzles, and executing processing for excluding the ejection failure nozzles from the calculation of the reference position.

The problems 4 to 6 and the means of solving these problems are similar to the problems 1 to 3 and the means of solving same according to the first mode.

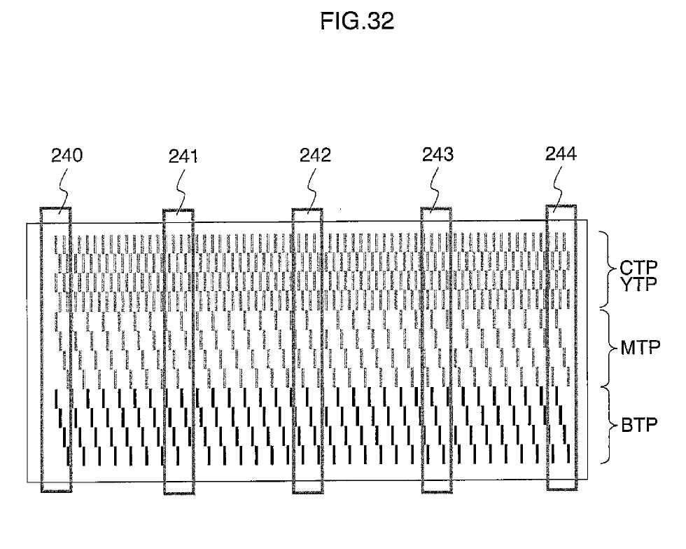

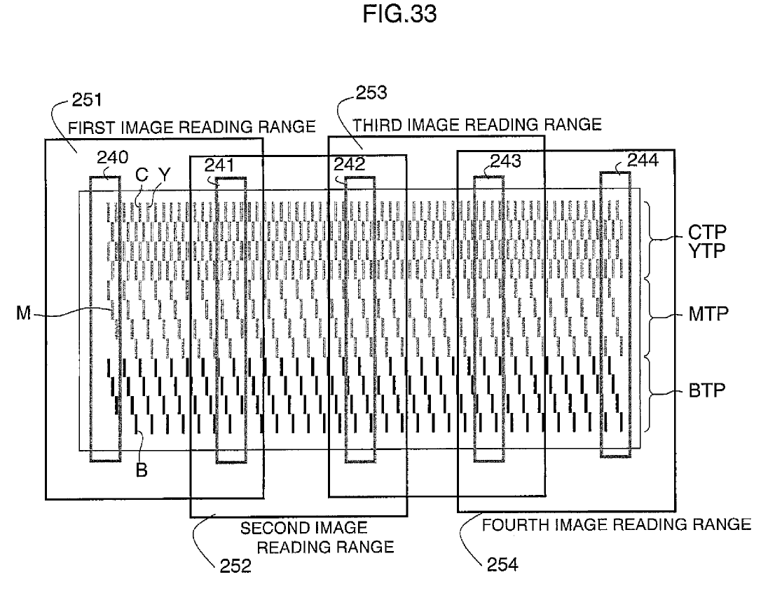

FIG. 32 is a first example of a single-sheet test chart created in the second mode. The single-sheet test chart shown in FIG. 32 is formed by a CMYK line head having nozzle numbers 0 to 4095, in which nozzle numbers 0 to 15 form reference line patterns, nozzle numbers 16 to 1023 form normal line patterns, and similarly thereafter, nozzle numbers 1024 to 1039 form reference line patterns, nozzle numbers 1040 to 2047 form normal line patterns, nozzle numbers 2048 to 2063 form reference line patterns, nozzle numbers 2064 to 3071 form normal line patterns, nozzle numbers 3072 to 3087 form reference line patterns, nozzle numbers 3088 to 4079 form normal line patterns and nozzle numbers 4080 to 4095 form reference line patterns.

In FIG. 32, the portions indicated by reference numerals 240 to 244 are the portions corresponding to the reference line pattern regions.

In the second mode, the line pattern blocks may be arranged in the manner described in the first mode. As described in the first mode, when the nozzles are categorized into four groups of: a first group having a remainder value of 0 calculated by dividing the nozzle number by 4; a second group having a remainder value of 1 calculated by dividing the nozzle number by 4; a third group having a remainder value of 2 calculated by dividing the nozzle number by 4; and a fourth group having a remainder value of 3 calculated by dividing the nozzle number by 4, the four line pattern blocks may be respectively formed for the four groups of the nozzles (for the remainders of 0 to 3). Moreover, as described in the first mode, four reference line patterns may be arranged in each of the four line pattern blocks. Furthermore, as described with reference to FIG. 13, the reference line patterns may have line characteristic quantities different from the others of the line patterns so that the reference line patterns can be identified visually.

As shown in FIG. 33, the image of a single-sheet test chart of this kind is read in by dividing into a plurality of reading operations while changing the reading position in such a manner that the reference line pattern regions are included at either end of each reading operation. More specifically, the region which includes the reference line pattern regions indicated by reference numerals 240 and 241 at either side is taken to be the first image reading region 251, the region which includes the reference line pattern regions indicated by reference numerals 241 and 242 at either side is taken to be the second image reading region 252, the region which includes the reference line pattern regions indicated by reference numerals 242 and 243 at either end is taken to be the third image reading region 253, and the region which includes the reference line pattern regions indicated by the reference numerals 243 and 244 at either end is taken to be the fourth image reading region 254.

The method of processing the test chart image which has been read in by dividing into four reading operations in this way is similar to the case of the first mode, and ejection failure judgment processing (as described in FIG. 14) of the test pattern blocks is carried out in respect of each image read in. The serial nozzle numbers corresponding to the reading sequence are acquired, and the absolute values of all of the nozzles are determined in such a manner that the duplicated line patterns coincide mutually.

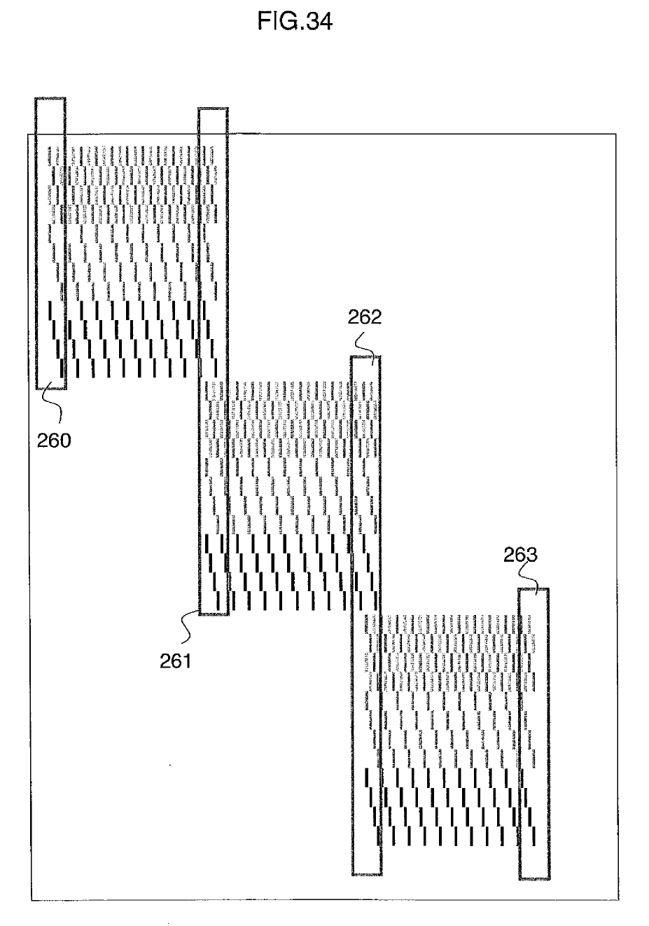

FIG. 34 is a diagram showing a second example of a single-sheet test chart. Instead of the test chart in FIG. 32, it is also possible to form a test chart such as that shown in FIG. 34. FIG. 34 shows an example of a single-sheet test chart which is formed by changing the printing position of the test pattern (a set of line pattern blocks which are recorded simultaneously), and each of the test patterns correspond to the image reading region of each reading operation. The method of printing the line patterns is the same as that of the example described in relation to FIG. 10, FIG. 13, and so on, and therefore further description thereof is omitted here. However, in the example in FIG. 34, the printed test chart is handled as a single sheet, rather than being split (cut) up.

In FIG. 34, reference numerals 260 to 263 are reference line pattern regions, and reference numerals 261 and 262 are reference line patterns and duplicated line patterns. By reading in the test chart by a plurality of operations while changing the reading position so as to include the reference line pattern regions at either end) it is possible to obtain absolute position information and line width information for all of the nozzles, by following similar processing to that of the first mode (where the test chart is split up), in respect of each of the read images obtained.

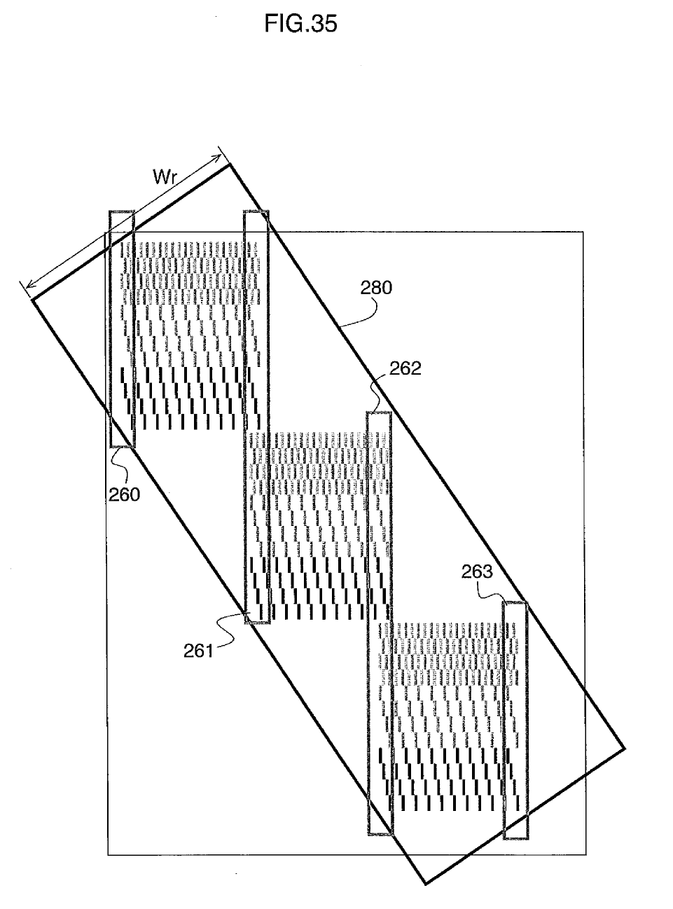

Furthermore, it is also possible to adopt a mode in which the image reading range enclosed by the thick line indicated by reference numeral 280 in FIG. 35 is read in, in respect of the single-sheet test chart in FIG. 34. As shown in FIG. 35, it is possible to read in all of the line patterns in one action by forming a test pattern in such a manner that the line patterns of all of the nozzles are contained within a uniform image reading width Wr, and then causing a line sensor having this image reading width Wr to move relatively (scan) in an oblique direction with respect to the test pattern. If the image is read in one action in this way, then it is possible to determine the absolute position information and line width information for all of the nozzles by following the processing of the first mode (where the test chart is split up) which was described previously in relation to each test pattern.

According to the embodiment (including the first mode and the second mode) of the present invention described above, the following action and beneficial effects are obtained.

(1) The reference line patterns in a test chart have characteristic quantities that are different from the others (i.e., normal line patterns) of the line patterns, and therefore the reference line patterns can be identified readily. Furthermore, droplet ejection is carried out in such a manner that a plurality of reference line patterns are formed with changing characteristic quantities to be arranged with a prescribed distribution. Therefore, even in cases where a particular reference line pattern is suffering an ejection failure, it is still possible to identify (deduce) the position of the line suffering ejection failure, from the other reference line patterns.

(2) Since the line pattern positions within the test charts are determined with reference to the reference line patterns while excluding those line patterns which correspond to ejection failure nozzles or abnormal nozzles, between test charts which are in a joined (connected) relationship, then it is possible to identify the line pattern positions of all of the nozzles, even if an abnormality (ejection failure) occurs in a portion of the plurality of reference line patterns.

(3) By adopting a mode in which the positional relationships of the respective blocks formed using regular nozzles (regularly arranged nozzles) are changed in each respective test chart, and/or a mode in which the positional relationships of the respective blocks formed using the regular nozzles of each ink are changed in each test chart, then it is possible to identify a test chart by identifying the arrangement sequence of the blocks formed by these regular nozzles, and the relative positions of the respective inks. By adopting this method, it is possible to join the split test charts together, automatically, in accurate positions. Furthermore, it is also possible to prevent the interchanging of test charts which were created at different times (namely, an error in the reading operation whereby test charts from different sets are mixed together.)

(4) Highly accurate image reading is possible using a scanning apparatus having an image reading width which is narrower than the recording width of the line head, and therefore costs can be reduced.

As described previously, according to the embodiment of the present invention, it is possible to measure the characteristics of recording elements (e.g., the dot positions and dot diameters created by the recording elements), with good accuracy, by using a scanning apparatus having a reading width which is narrower than the effective area of the test pattern formed by all of the recording elements of the line head.

Consequently, if the test pattern is divided up and split into a plurality of test charts, the sequential relationship of these test patterns is judged automatically, and therefore it is possible to measure the characteristics of the recording elements (e.g., the dot positions and dot diameters created by the recording elements) with good accuracy, without the occurrence of operational errors (for instance, incorrect sequence of the test charts, intermixing of similar test charts from a previous measurement operation, and so on).

By means of the technology disclosed in the present specification, it is possible to measure the characteristics of the recording elements of a long line head, readily and inexpensively, by using a commercial flatbed scanner.

In the respective embodiments described above, an inkjet recording apparatus using a page-wide full line type head having a nozzle row of a length corresponding to the entire width of the recording medium was described, but the scope of application of the present invention is not limited to this, and the present invention may also be applied to an inkjet recording apparatus which performs image recording by means of a plurality of head scanning actions which move a short recording head, such as a serial head (shuttle scanning head), or the like.

In the foregoing description, an inkjet recording apparatus was described as one example of an image forming apparatus, but the scope of application of the present invention is not limited to this. It is also possible to apply the present invention to image recording apparatuses employing various types dot recording methods, apart from an inkjet apparatus, such as a thermal transfer recording apparatus equipped with a recording head which uses thermal elements (heaters) are recording elements, an LED electrophotographic printer equipped with a recording head having LED elements as recording elements, or a silver halide photographic printer having an LED line type exposure head, or the like.

Furthermore, the meaning of the term “image forming apparatus” is not restricted to a so-called graphic printing application for printing photographic prints or posters, but rather also encompasses industrial apparatuses which are able to form patterns that may be perceived as images, such as resist printing apparatuses, wire printing apparatuses for electronic circuit substrates, ultra-fine structure forming apparatuses, etc., which use inkjet technology.

In other words, the present invention can be applied widely as measurement technology for measuring dot depositing positions and dot diameters (droplet volumes) in various types of liquid ejection apparatuses which eject (spray) liquid, such as commercial fine application apparatuses, resist printing apparatuses, wiring printing apparatuses for electronic circuit boards, dye processing apparatuses, coating apparatuses, and the like.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A test chart which is recorded on a recording medium by means of a line head having a plurality of recording elements by causing the plurality of recording elements to perform recording operation while moving the recording medium and the line head relatively to each other in a relative movement direction, the test chart comprising:
a line pattern block which includes a plurality of line patterns respectively corresponding to the plurality of recording elements, the plurality of line patterns being arranged at a prescribed interval or above so as to be separated from each other,
wherein the plurality of line patterns include reference line patterns arranged on both end regions of the line pattern block, the reference line patterns having line characteristic quantities different from the others of the plurality of line patterns.

2. The test chart as defined in claim 1, wherein the reference line patterns include a first reference line pattern having a first line characteristic quantity and a second reference line pattern having a second line characteristic quantity, the first line characteristic quantity being different from the second line characteristic quantity.

3. The test chart as defined in claim 1, wherein:
the test chart includes a plurality of the line pattern blocks; and
a row of the plurality of recording elements is divided into a plurality of recording element regions which form the line pattern blocks respectively, the plurality of recording element regions mutually overlapping so that the reference line patterns in adjacent two of the line pattern blocks are recorded by common recording elements belonging to two of the recording element regions corresponding to the adjacent two of the line pattern blocks.

4. The test chart as defined in claim 1, wherein:
the plurality of recording elements in the line head are arranged at mutually different positions in a first direction that intersects with the relative movement direction;
the test chart includes a plurality of the line pattern blocks, a number of the line pattern blocks in the test chart being α that is an integer not less than 2, the line pattern blocks being arranged at mutually different positions in a second direction that is parallel with a direction in which each of the plurality of line patterns extends; and
when recording element numbers j (j=0, 1, 2, . . . , N−1) are assigned to the plurality of recording elements sequentially from one end of a sequence of the plurality of recording elements, and when a remainder value generated by dividing each of the recording element numbers by the integer α is taken to be R (R=0, 1, . . . , α−1), each of the line pattern blocks is formed by a group of the plurality of recording elements having the same remainder value R so that the line pattern blocks are formed for the remainder values R, respectively.

5. The test chart as defined in claim 4, further comprising a plurality of test patterns each of which is constituted of the line pattern blocks corresponding to the remainder values R, the test patterns having mutually different arrangement sequences of the line pattern blocks, the test patterns being identifiable based on the arrangement sequences of the line pattern blocks.

6. A test chart measurement method, comprising the steps of:
reading in the test chart as defined in claim 1 to obtain an image of the test chart by means of an image reading device; and
identifying an abnormal recording element in the plurality of recording elements from the image of the test chart obtained in the step of reading in the test chart, according to distribution of the reference line patterns having the line characteristic quantities different from the others of the plurality of line patterns.

7. A test chart measurement method, comprising the steps of:
reading in the test chart as defined in claim 3 to obtain images respectively for regions of the test chart corresponding to the plurality of recording element regions; and
identifying an abnormal recording element in the plurality of recording elements by analyzing the images of the test chart obtained in the step of reading in the test chart, according to distribution of the reference line patterns having the line characteristic quantities different from the others of the plurality of line patterns.

8. A test chart measurement apparatus, comprising:
an image reading device which reads the test chart as defined in claim 1 to convert the test chart to image data; and
a calculation processing device which analyzes the image data of the test chart obtained by the image reading device to identify an abnormal recording element in the plurality of recording elements, according to distribution of the reference line patterns having the line characteristic quantities different from the others of the plurality of line patterns.

9. The test chart measurement apparatus as defined in claim 8, wherein the calculation processing device includes:
information identification device which identifies information relating to positions, line widths and the line characteristic quantities of the line patterns of the line pattern blocks in the image data of the test chart obtained by the image reading device; and
abnormal line judgment device which judges whether or not there exist an abnormal line pattern in the line patterns, according to previously known information relating to the line characteristic quantities and the distribution of the reference line patterns, the abnormal line pattern being formed by the abnormal recording element.

10. A computer readable medium storing instructions causing a computer to function as the information identification device and the abnormal line judgment device in the test chart measurement apparatus as defined in claim 9.
